(19) United States
(12) Patent Application Publication
(10) Pub. No.: US 2026/0200640 A1
(43) Pub. Date: Jul. 16, 2026

(54) CUSHION SHEET PRODUCTION MODULE AND PACKAGING BAG PRODUCTION DEVICE THEREOF

(71) Applicants: BETA (SHENZHEN) PACKAGE PRODUCTS CO., LTD, Shenzhen (CN); HUIZHOU BETA PACKTECH CO., LTD, Huizhou (CN)

(72) Inventor: Jinwei Yan, Shenzhen (CN)

(73) Assignees: BETA (SHENZHEN) PACKAGE PRODUCTS CO., LTD, Shenzhen (CN); HUIZHOU BETA PACKTECH CO., LTD, Huizhou (CN)

(21) Appl. No.: 19/560,046

(22) Filed: Mar. 8, 2026

Related U.S. Application Data
(63) Continuation-in-part of application No. 18/666,334, filed on May 16, 2024.
Application No. 18/666,334 is a continuation-in-part of application No. 18/208,908, filed on Jun. 13, 2023, now Pat. No. 12,017,820.
Application No. 18/208,908 is a continuation-in-part of application No. 17/223,029, filed on Apr. 6, 2021, now Pat. No. 11,731,808.
Application No. 17/223,029 is a continuation-in-part of application No. 16/878,645, filed on May 20, 2020, now abandoned.
Application No. 16/878,645 is a division of application No. 16/795,554, filed on Feb. 19, 2020, now Pat. No. 10,850,891.
(63) Continuation-in-part of application No. PCT/CN2024/127243, filed on Oct. 25, 2024.
Application No. 17/223,029 is a continuation-in-part of application No. PCT/CN2019/121161, filed on Nov. 27, 2019.
Application No. PCT/CN2019/121161 is a continuation-in-part of application No. PCT/CN2019/110740, filed on Oct. 12, 2019.
Application No. PCT/CN2019/110740 is a continuation-in-part of application No. PCT/CN2019/090469, filed on Jun. 10, 2019.

(30) Foreign Application Priority Data
Mar. 29, 2019 (CN) 201910252856.0
Mar. 29, 2019 (CN) 201920419356.7
Aug. 8, 2019 (CN) 201910731634.7
Mar. 3, 2021 (CN) 202110237367.5
Aug. 22, 2022 (CN) 202211009671.5
Sep. 8, 2023 (CN) 202311164505.7
Apr. 16, 2024 (CN) 202410457007.X

(51) Int. Cl. B65D 30/08; B31B 70/00; B31B 70/02; B31B 70/14; B31B 70/16; B31B 70/20; B31B 70/26; B31B 70/62; B31D 5/00; B32B 1/00; B32B 3/26; B32B 29/00; B65D 65/40; B65D 65/46; B65D 81/02; B65D 81/03

(52) U.S. Cl. CPC B65D 31/02; B31B 70/005; B31B 70/02; B31B 70/024; B31B 70/142; B31B 70/16; B31B 70/20; B31B 70/26; B31B 70/62; B31D 5/0065; B32B 1/00; B32B 3/266; B32B 29/005; B65D 65/406; B65D 65/44; B65D 65/466; B65D 81/03; B32B 2439/06

(57) ABSTRACT

A cushion sheet production module includes a first unreeling unit for unreeling a first sheet, a buffer layer feeding unit for unreeling a buffer layer above the first sheet, the buffer layer and the first sheet fed along a feeding direction, glue applied on the buffer layer and/or the first sheet, a paper pressing unit for rolling and pressing the first sheet and the buffer layer, a cutting unit arranged between the paper pressing and buffer layer feeding units and configured to roll and cut the buffer layer with cut positions spaced apart and perpendicular to the feeding direction, the buffer layer feeding unit fed at a speed lower than the first unreeling unit to form uncovered intervals on the first sheet, the intervals formed to feed the buffer layer further at a speed same as the first sheet, to connect the buffer layer with the first sheet.

### 1. CROSS-REFERENCE TO RELATED APPLICATIONS

This application is a continuation-in-part of U.S. application Ser. No. 18/666,334, filed on May 16, 2024, which is a continuation-in-part of U.S. application Ser. No. 18/208,908, filed on Jun. 13, 2023, which is a continuation-in-part of U.S. application Ser. No. 17/223,029, filed on Apr. 6, 2021, which is a continuation-in-part of U.S. application Ser. No. 16/878,645, filed on May 20, 2020, which is a division of U.S. application Ser. No. 16/795,554, filed on Feb. 19, 2020. U.S. application Ser. No. 17/223,029, filed on Apr. 6, 2021, is a continuation-in-part of International Application No. PCT/CN2019/121161, filed on Nov. 27, 2019, and is a continuation-in-part of International Application No. PCT/CN2019/110740, filed on Oct. 12, 2019, and is a continuation-in-part of International Application No. PCT/CN2019/090469, filed on Jun. 10, 2019. application Ser. No. 18/666,334 claims priority to Chinese Application No. 202211009671.5, filed on Aug. 22, 2022, Chinese Application No. 202110237367.5, filed on Mar. 3, 2021, Chinese Application No. 201910731634.7, filed on Aug. 8, 2019, Chinese Application No. 201920419356.7, filed on Mar. 29, 2019, and Chinese Application No. 201910252856.0, filed on Mar. 29, 2019, Chinese Application No. 202311164505.7, filed on Sep. 8, 2023. This application is also a continuation-in-part of International Application No. PCT/CN2024/127243, filed on Oct. 25, 2024, which claims priority to Chinese Application No. 202311164505.7, filed on Sep. 8, 2023, and Chinese Application No. 202410457007.X, filed on Apr. 16, 2024. The entire contents of all of the above-identified patent applications are incorporated herein by reference.

### BACKGROUND

### 2. Technical Field

The present disclosure generally relates to the field of p express logistics, and especially relates to a cushion sheet production module and a packaging bag production device thereof.

### 3. Description of Related Art

Referring to FIG. 1, a conventional cushion packaging bag 100a is formed by folding a bottom A of a conventional cushion sheet 10a with cushioning effect and sealing two sides B of the cushion sheet 10a. Alternatively, two cushion sheets 10a are used to produce the conventional cushion packaging bag 100a by bonding two edges B of both sides of the two cushion sheets 10a and the bottom A together. The bottom A is pasted that includes directly pasting the two bottoms A of the two cushion sheets 10a with each other, or flipping one of the two bottoms A of the two cushion sheets 10a to be pasted, wherein flipping the bottom A to be pasted refers to overlapping the two cushion sheets 10a with each other, folding and wrapping the bottom A of one cushion sheet 10a towards the bottom A of the other cushion sheet 10a, and then pasting the folded part onto the other cushion sheet 10a.

It can be seen from the production process of the cushion packaging bag 100a above that in the process of producing the cushion packaging bag 100a, a first step is to produce the cushion sheets 10a/10b. A production speed of the cushion sheet 10a directly affects a production efficiency of the cushion packaging bag 100a.

Referring to FIG. 1 and FIG. 2, as for the cushion sheet 10a itself, it consists of at least two layers that are an outer layer A1 and a buffer layer B1. The outer layer A1 forms an outer wall of the cushion packaging bag 100a after the cushion sheet 10a is made to the cushion packaging bag 100a, and the buffer layer B1 is located inside the outer wall and is also used to package items into the packaging bag. The common cushion sheet 10a can also include a three-layer structure, which is shown in FIG. 3, that is an outer layer A1, the buffer layer B1, and an inner layer C1. The buffer layer B1 is arranged between the outer layer A1 and the inner layer C1, which can be a single-layer structure or a multi-layer structure. The entire buffer layer B1 or at least a part of the buffer layer B1 needs to be pasted on the outer layer A1 or the inner layer C1 to fix the buffer layer B1.

Referring to FIG. 4a to FIG. 4d, the cushion sheet 10a has the following types according to different structures of the buffer layer B1.

Firstly, as shown in FIG. 4a, a cross section of the buffer layer B1 is a wavy corrugated paper structure.

Secondly, the buffer layer B1 is a concave convex structure after being molded, as shown in FIG. 4b.

Thirdly, the buffer layer B1 is a plastic bubble film, as shown in FIG. 4c.

Fourthly, the buffer layer B1 is a three-dimensional hexagonal grid structure that is formed by stretching a slit paper, as shown in FIG. 4d. The slit paper 20a refers to cutting broken blades 21a on a paper material. A plurality of blades 21a is arranged in rows and columns, the blades 21a in the same row are spaced apart from each other and the blades 21a in adjacent rows offset from each other. When this type of slit paper 20a is stretched, it will be twisted and stretched into a three-dimensional hexagonal opening 22a at the blade 21a, for causing the slit paper 20a to expand in a thickness direction thereof and thereby having a buffering function thereof.

The conventional cushion sheet, whether it is a two-layer structure or a three-layer structure as mentioned above, and whether the buffer layer has one or more layers, and whether the buffer layer has any of the specific structures mentioned above, all or a part of the buffer layer needs to be adhered to the outer and/or inner layers during the production process.

Referring to FIG. 5, which is also the subject matter claimed in U.S. application Ser. No. 18/666,334, as well as contents of International Application No. PCT/CN2023/122464. It should be noted that technical contents associated with FIG. 5 is not necessarily recognized as the related art that is already disclosed before a filing date of the present disclosure, which merely represents the closest known technology as understood by the applicant.

As is disclosed in U.S. application Ser. No. 18/666,334, when an automation apparatus is used to produce the cushion sheet 10a, it is necessary to feed a belt-shaped buffer layer B1 with a roll material at the same time as the belt-shaped outer layer A1 and the belt-shaped inner layer A1 with roll materials. The buffer layer B1, the inner layer and the outer layer A1 are stacked vertically while feeding all of the buffer layer B1, the inner layer and the outer layer A1. When the belt-shaped buffer layer B1 is adhered to the belt-shaped inner layer and/or the belt-shaped outer layer A1, the belt-shaped cushion sheet 10a is formed. However, the buffer layer B1 itself has a buffering effect and a certain thickness. When the buffer layer B1 is adhered to the inner layer and/or the outer layer A1, in addition to applying glue to bonding positions of the inner layer and/or the outer layer A1, it is also necessary to heat and press the buffer layer B1 and the inner/outer layers A1 at the bonding positions in order to ensure that the applied glue has a maximum bonding force and firmly fix the buffer layer B1 to the inner layer and/or the outer layer A1. Moreover, during the compression process, the buffer layer B1 needs to be compressed into a flat surface at the position of sizing glue, so as to fully contact and fix the adhesive surface of the outer and/or inner layers.

When using the above production process to manufacture the cushion sheet, the heating and pressing process takes a lot of time, and the pressing process needs to be maintained for a period of time to laminate the buffer layer into the flat surface. In addition, the applied glue also needs to be heated for a period of time.

In the related art, when the production equipment adopts an intermittent step feeding mode, that is, after feeding for a period of time, the feeding is stopped. The heating and pressing structure heats and presses the positions where the buffer layer and the inner/outer layers need to be pasted during the stopping time. After the heating and pressing are completed, it continues to be fed for a period of time, and then it stops the feeding and repeats in sequence. In addition, in some production equipment, after being heated and pressed, it is necessary to heat the cushion sheet again to achieve a purpose of drying and further curing the glue. In this type of production equipment, the feeding is in a stopped state for a period of time, which reduces the production efficiency of the entire cushion sheet. This step-by-step feeding production equipment produces cushion sheets with a length of no more than 50 m per minute.

On the other hand, when two strip-shaped cushion sheets are fed and stacked with each other to make the cushion packaging bag, because the two strip-shaped cushion sheets are opposite to each other, so that they need for sizing glue at positions of the two cushion sheets that are spaced apart in the feeding direction, thereby heating and pressing the positions of sizing glue, and the positions of sizing glue are to form two sides of the packaging bag after the two cushion sheets are produced and cut. That is to say, when making the cushion packaging bags by using the cushion sheets, the heating and pressing process is also required to fix the two cushion sheets to each other to further form the cushion packaging bag, which also needs to overcome the technical problem of low production efficiency mentioned above.

Furthermore, a time for the heating and pressing process is also related to the structure of the buffer layer itself. The better the buffering effect of the buffer layer, the longer the heating and pressing time, because the buffer layer is more difficult to be pressed into the flat surface and needs to be in contact with the glue for a longer time in order to be fixed. For such production equipment, it is necessary to set different step feeding modes according to the production of cushion sheets and cushion packaging bags with different buffer layers, that is, a step feeding time and a step stopping time. This makes it difficult to form a cushion sheet and a cushion packaging bag production device that is compatible with all structures of buffer layers.

### SUMMARY

The technical problems to be solved: in view of the shortcomings of the related art, the present disclosure provides a cushion sheet production module and a packaging bag production device thereof which can solve problems that low production efficiency is occurred in the cushion sheet of the related art above mentioned and the cushion sheet production module of the related art above mentioned is unable to be compatible with buffer layers with multiple different structures.

A cushion sheet production module of the present disclosure configured to produce a cushion sheet and including a feeding direction to produce the cushion sheet, the cushion sheet comprising a first sheet and a buffer layer, the cushion sheet production module includes:
a first unreeling unit configured to unreel the first sheet at a first feeding speed, wherein the first sheet is continuously fed along the feeding direction after the first sheet is unreeled;
a buffer layer feeding unit configured to unreel the buffer layer at a changing speed along the feeding direction, the buffer layer arranged above or below the first sheet and opposite to the first sheet, wherein a surface of the buffer layer facing the first sheet is coated with glue, or a surface of the first sheet facing the buffer layer is coated with glue, or the surfaces of the buffer layer and the first sheet facing each other are coated with glue, the glue configured to paste the first sheet and the buffer layer together;
a cutting unit arranged behind the buffer layer feeding unit along the feeding direction, and configured to roll and cut the buffer layer during feeding the buffer layer, positions that the buffer layer are cut arranged on the buffer layer at intervals and set perpendicular to the feeding direction; and wherein
the buffer layer is cut to be separated into a plurality of cushion units arranged in a row from beginning to end, each of the plurality of cushion units including a first end and a second end arranged along the feeding direction and opposite to each other, the second end of a previous cushion unit adjacent to the first end of a current cushion unit;
a paper pressing unit arranged behind the cutting unit along the feeding direction and configured to roll and press against positions of the glue set on the first sheet and/or the buffer layer to paste the first sheet and the buffer layer; and wherein
each cushion unit is sequentially fed to the paper pressing unit from the first end to the second end, and the plurality of cushion units are fixed on the first sheet after the plurality of cushion units is pressed against by the paper pressing unit; and wherein
the changing speed includes a second feeding speed and a third feeding speed, the third feeding speed equal to the first feeding speed and the second feeding speed smaller than the first feeding speed; and wherein
a plurality of intervals is formed on the first sheet, each of the plurality of intervals arranged between the first end of the current cushion unit and the second end of the previous cushion unit; and wherein after the buffer layer is cut by the cutting unit, the buffer layer feeding unit is continuously fed at the second feeding speed, until one of the plurality of intervals is reserved on the first sheet, and when the first end of the current cushion unit is fixed on the first sheet, the buffer layer feeding unit is fed at the third feeding speed continuously and synchronously with the first sheet.

Another cushion sheet production module of the present disclosure is provided and includes a feeding direction thereof. The cushion sheet production module includes:
a first unreeling unit configured to unreel a first sheet at a first feeding speed, wherein the first sheet is continuously fed along the feeding direction after the first sheet is unreeled;
a third unreeling unit configured to unreel a third sheet at a speed along the feeding direction to make the third sheet to be continuously fed along the feeding direction, wherein the third sheet is provided with wrinkles extending along the feeding direction;
a slit paper unreeling unit configured to unreel a slit paper at a changing speed along the feeding direction to make the slit paper to be continuously fed along the feeding direction, the slit paper arranged between the first sheet and the third sheet, wherein a surface of the slit paper facing the third sheet is provided with the glue, or a surface of the third sheet facing the slit paper is provided with the glue, and the glue is set along two edges in the feeding direction, and configured to paste at the two edges of the slit paper and the third sheet in the feeding direction; and wherein the one edge of the slit paper that faces the surface of the first sheet along the feeding direction is provided the glue, or the glue is provided on the surface of the first sheet corresponding to the one edge of the slit paper along the feeding direction, for only connecting the one edge of the slit paper along the feeding direction to the first sheet;
a slit paper cutting unit arranged behind the slit paper unreeling unit along the feeding direction and configured to cut the slit paper;
a cutting unit arranged behind the third unreeling unit along the feeding direction and configured to roll and cut the third sheet during feeding the third sheet, cutting positions of the third sheet arranged on the third sheet at intervals and perpendicular to the feeding direction;
a paper pressing unit arranged behind the cutting unit along the feeding direction and configured to roll and press against the first sheet, so that the first sheet is connected to the one edge of the slit paper that is applied the glue, and the two edges of the slit paper that are applied the glue are connected to the third sheet; and wherein
the slit paper is cut to be separated into a plurality of slit paper units sequentially arranged in a row from beginning to end, the third sheet is cut to be separated into a plurality of third sheet units sequentially arranged in a row from beginning to end, each adjacent two slit paper units connected to one of the plurality of third sheet units, to form a corresponding cushion unit vertically;
the plurality of cushion units arranged in a row from beginning to end, each of the plurality of cushion units including a first end and a second end arranged along the feeding direction and opposite to each other, the second end of a previous cushion unit adjacent to the first end of a current cushion unit; and wherein each cushion unit is sequentially fed to the paper pressing unit from the first end to the second end, and the plurality of cushion units are fixed on the first sheet after the plurality of cushion units is pressed against by the paper pressing unit; and wherein
each of the plurality of slit paper units includes a third end and a fourth end opposite to each other along the feeding direction, and in the same cushion unit, the fourth end of a current slit paper unit corresponding to the second end of the cushion unit, and the third end of a previous slit paper unit corresponding to the first end of the cushion unit; and wherein
each of the plurality of third sheet units includes a fifth end and a sixth end opposite to each other along the feeding direction, and in the same cushion unit, the fifth end of a current third sheet unit corresponding to the first end of the cushion unit, and the sixth end of a next third sheet unit corresponding to the second end of the cushion unit; and wherein
a plurality of intervals is formed on the first sheet, each of the plurality of intervals arranged between the first end of the current cushion unit and the second end of the previous cushion unit, the plurality of intervals arranged along a direction perpendicular to the feeding direction, and arranged along the feeding direction at intervals; and wherein
the changing speed includes a second feeding speed, a third feeding speed and a fourth feeding speed, the third feeding speed equal to the first feeding speed, the second feeding speed smaller than the first feeding speed, and the fourth feeding speed greater than the first feeding speed; and wherein
the speed of the third unreeling unit includes the second feeding speed and the third feeding speed; and wherein
when the fifth end of the current third sheet unit corresponds to an end position of the interval of the first sheet, the third unreeling unit feeds the third sheet at the third feeding speed, so that the third sheet is fed synchronously with the first sheet; and when the sixth end of the current third sheet unit corresponds to a starting position of the interval of the first sheet, the third unreeling unit feeds the third sheet at the second feeding speed until the fifth end of the next third sheet unit corresponds to the starting position of an adjacent interval of the first sheet; and wherein
when the third end of the previous slit paper unit corresponds to the end position of the interval of the first sheet, the slit paper unreeling unit feeds the slit paper at the third feeding speed, so that the slit paper is synchronously fed with the first sheet and the third sheet; and when the fourth end of the previous slit paper unit is fed to a predetermined position between two adjacent intervals of the first sheet, the slit paper unreeling unit feeds the slit paper at the fourth feeding speed, and the third end of the current slit paper unit that is fed at the fourth feeding speed is overlapped with the fourth end of the previous slit paper unit; and wherein
when the third end of the current slit paper unit is overlapped with the fourth end of the previous slit paper unit by a predetermined width, the slit paper unreeling unit continues to feed the slit paper at the third feeding speed until the fourth end of the current slit paper unit is located at the starting position of the adjacent interval, at this time, the slit paper unreeling unit feeds the slit paper at the second feeding speed until the third end of the next slit paper unit corresponds to the ending position of the adjacent interval.

A packaging bag production device of the present disclosure includes the above two cushion sheet production modules configured to produce two cushion sheets, respectively, wherein the two cushion sheets produced by the two cushion sheet production modules are respectively taken as a first cushion sheet and a second cushion sheet, the first cushion sheet and the second cushion sheet are stacked vertically opposite to each other and synchronously fed along the feeding direction; and wherein
a structure of the first cushion sheet is the same as that of the second cushion sheet, the first sheet of the first cushion sheet arranged above the buffer layer of the first cushion sheet, the buffer layer of the first cushion sheet arranged above the buffer layer of the second cushion sheet, and the first sheet of the second cushion sheet arranged below the buffer layer of the second cushion sheet, the first sheets of the first cushion sheet the second cushion sheet including the plurality of intervals; and wherein
the packaging bag production device further includes:
a first bag gluing unit arranged behind the first unreeling unit along the feeding direction and configured to apply glue on the first cushion sheet and/or the second cushion sheet, first positions of the first cushion sheet and/or the second cushion sheet that the glue is applied by the first bag gluing unit arranged at intervals, and a direction of the first positions that are applied the glue perpendicular to the feeding direction, wherein the first positions are arranged on the plurality of intervals of the first cushion sheet or the second cushion sheet, or are arranged on positions that are corresponding to the plurality of intervals of the first cushion sheet; wherein the first positions are set on a surface of the first cushion sheet facing the second cushion sheet, or set on a surface of the second cushion sheet facing the first cushion sheet, or set on the surface of the first cushion sheet facing the second cushion sheet and the surface of the second cushion sheet facing the first cushion sheet, respectively; and
a first bag pressing unit arranged behind the first bag gluing unit along the feeding direction and configured to roll and press against the first cushion sheet and the second cushion sheet to connect the first cushion sheet and the second cushion sheet at the first positions thereof, to form two sides of a packaging bag.

The cushion sheet production module and the packaging bag production device of the present disclosure can be compatible with producing buffer layers with multiple different structures, and no buffer layer is set when pressing and pasting at adjacent intervals thereof. Compared to the related art, the buffer layer does not need to be flattened at the intervals, nor does it require more pressing and heating times. At the same time, continuously applying the glue by a continuous feeding mode, rolling cutting and rolling pressing are occurred, which can greatly improve the overall production efficiency thereof.

### BRIEF DESCRIPTION OF THE DRAWINGS

FIG. 1 is a schematic view of conventional cushion packaging bag.

FIG. 2 is a schematic view of feeding a conventional cushion sheet.

FIG. 3 is a schematic view of feeding another conventional cushion sheet.

FIG. 4a is a schematic view of a buffer layer with a wavy corrugated paper structure.

FIG. 4b is a schematic view of a buffer layer with a concave convex structure.

FIG. 4c is a schematic view of a buffer layer which is a plastic bubble film.

FIG. 4d is a schematic view of a buffer layer that is formed by stretching a slit paper.

FIG. 5 is a schematic view of a cushion sheet production module of other patent applications of applicant.

FIG. 6 is a schematic view of a cushion sheet production module in accordance with a first embodiment of the present disclosure.

FIG. 7 is a schematic view of a cutting unit of the cushion sheet production module of the present disclosure.

FIG. 8a to FIG. 8e are schematic views of sizing glue on positions of a first sheet by a first sizing glue unit of the present disclosure.

FIG. 9 is a schematic view of using the cushion sheet production module of the first embodiment to produce a packaging bag of the present disclosure.

FIG. 10 is a schematic view of a cushion sheet production module in accordance with a second embodiment of the present disclosure.

FIG. 11 is a schematic view of a cushion sheet production module in accordance with a third embodiment of the present disclosure.

FIG. 12 is a schematic view of a rolling-pressing unit of the cushion sheet production module of the present disclosure.

FIG. 13 is a schematic view of using a cushion sheet production module to produce a cushion sheet and a partial structure of the cushion sheet production module in accordance with a fourth embodiment of the present disclosure.

FIG. 14 is a schematic view of the cushion sheet production module of the fourth embodiment of the present disclosure.

FIG. 15 is a schematic view of the cushion sheet produced by the cushion sheet production module of FIG. 14.

FIG. 16 is a schematic view of using a cushion sheet production module to produce a cushion sheet and a partial structure of the cushion sheet production module in accordance with a fifth embodiment of the present disclosure.

FIG. 17 is a schematic view of the cushion sheet production module of the fifth embodiment of the present disclosure.

FIG. 18 is a schematic view of the cushion sheet produced by the cushion sheet production module of FIG. 17.

FIG. 19 is a schematic view of using a cushion sheet production module in accordance with a sixth embodiment of the present disclosure to produce a cushion sheet and a partial structure of the cushion sheet production module thereof.

FIG. 20 is a schematic view of the cushion sheet production module of the sixth embodiment of the present disclosure.

FIG. 21 is a schematic view of the cushion sheet produced by the cushion sheet production module of FIG. 20.

FIG. 22 is a schematic view of a packaging bag production device in accordance with a first embodiment of the present disclosure.

FIG. 23 is a working schematic view of a cushion packaging bag produced by the packaging bag production device of FIG. 22 by using the cushion sheet produced by the cushion sheet production module of FIG. 6.

FIG. 24 is a working schematic view of a cushion packaging bag produced by the packaging bag production device of FIG. 22 by using the cushion sheet produced by the cushion sheet production module of FIG. 11.

FIG. 25 is a schematic view of a packaging bag production device in accordance with a second embodiment of the present disclosure.

FIG. 26 is a schematic view of a cushion sheet produced by the packaging bag production device of FIG. 25.

FIG. 27 is a cross-sectional view of a cushion packaging bag produced by the cushion sheet that is unstretched of FIG. 26.

FIG. 28 is a cross-sectional view of the cushion packaging bag produced by the cushion sheet that is stretched of FIG. 27.

FIG. 29 is a schematic view of a cushion packaging bag produced by the packaging bag production device of FIG. 25.

FIG. 30 is a top view of the cushion sheet of the cushion packaging bag produced in FIG. 29, shown the cushion sheet is stretched.

### DETAILED DESCRIPTION

The present disclosure will be further illustrated and described with reference to embodiments, examples and the accompanying drawings of the specification.

### A First Embodiment of the Present Disclosure

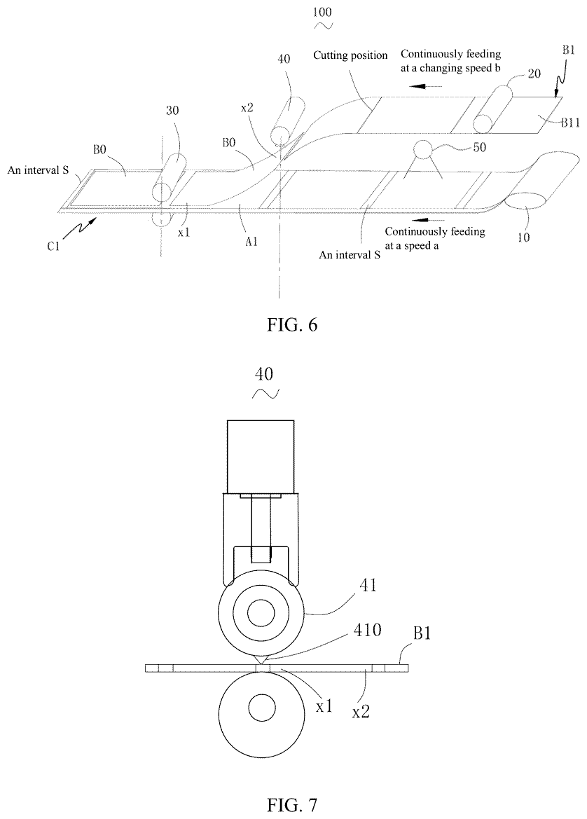

Referring to FIG. 6, the present disclosure provides a cushion sheet production module 100 configured to produce a cushion sheet C1 and including a feeding direction to produce the cushion sheet C1. The cushion sheet C1 includes a first sheet A1 and a buffer layer B1, and the cushion sheet production module 100 includes: a first unreeling unit 10, a buffer layer feeding unit 20, a paper pressing unit 30 and a cutting unit 40.

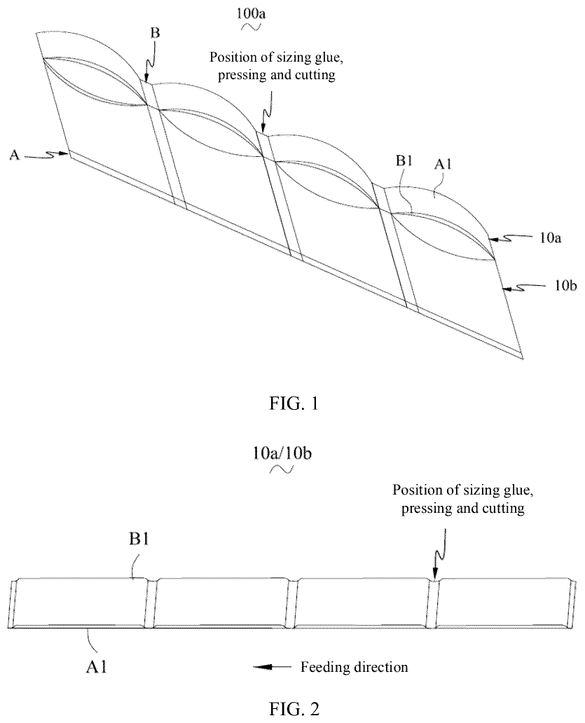

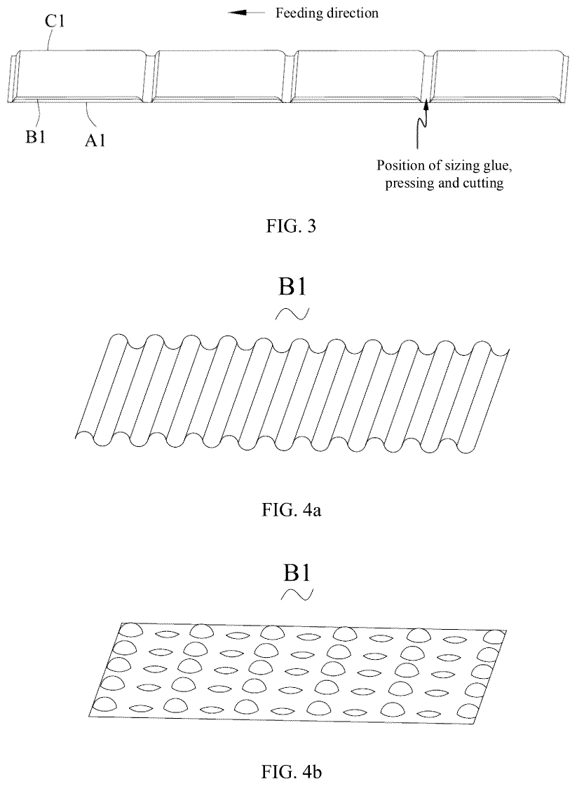

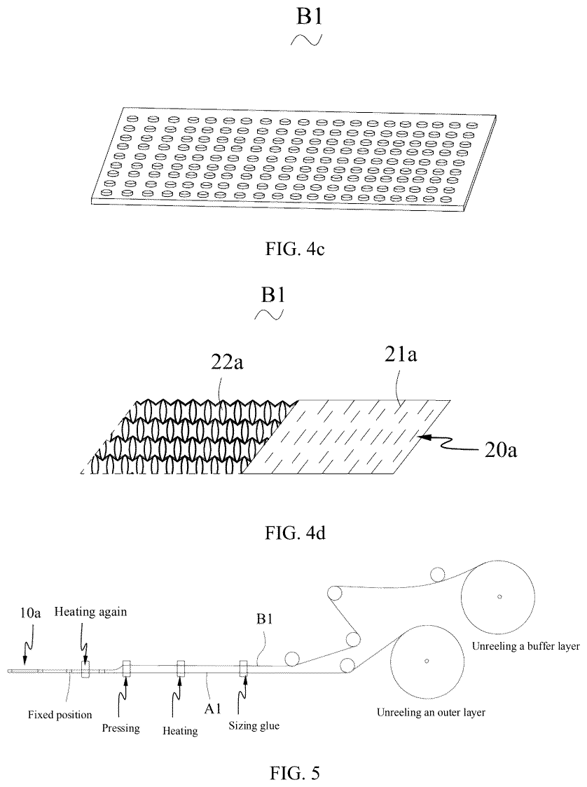

The first unreeling unit 10 is configured to unreel the first sheet A1 at a first feeding speed a, wherein the first sheet A1 is continuously fed along the feeding direction after the first sheet A1 is unreeled. The feeding direction is a direction as an arrow is shown in FIG. 1. The continuous feeding in the present disclosure is referred to uninterrupted and non-stop continuous transporting or unreeling, which is different from a step-by-step feeding.

The buffer layer feeding unit 20 is configured to unreel the buffer layer B1 at a changing speed b along the feeding direction, the buffer layer B1 arranged above or below the first sheet A1. Glue is applied to the buffer layer B1 and/or the first sheet A1 for pasting the first sheet A1 and the buffer layer B1. The glue that is applied can be pre-applied before unreeling the first sheet A1 or applied during feeding the first sheet A1 or the buffer layer B1. It is only necessary to ensure that the glue can paste the first sheet A1 and the buffer layer B1 together, or at least one part of the first sheet A1 and the buffer layer B1 can paste together, rather than being detached from each other.

The cutting unit 40 is arranged behind the buffer layer feeding unit 20 along the feeding direction, arranged in front of the paper pressing unit 30 along the feeding direction, and close to a side of the first unreeling unit 10, that is, arranged between the first unreeling unit 10 and the paper pressing unit 30 as shown in FIG. 1. The cutting unit 40 is configured to roll and cut the buffer layer B1 at the same time interval during feeding the buffer layer B1, and positions of cutting the buffer layer B1 is perpendicular to the feeding direction.

The paper pressing unit 30 is arranged behind the cutting unit 40 along the feeding direction and configured to roll and press against positions of the glue set on the first sheet A1 and/or the buffer layer B1 to paste the first sheet A1 and the buffer layer B1. The paper pressing unit 30 also rolls continuously, with a rolling speed that is the same as and synchronized with a speed of the first unreeling unit 10, which can ensure that the first sheet A1 and the buffer layer B1 are fixed to each other at the gluing positions as much as possible, without a situation where some gluing positions are not fixed.

In an embodiment of the present disclosure, An interval cutting mode can cut the buffer layer B1 into a plurality of independent cushion units B0, while rolling and together with cutting can cut the buffer layer B1 synchronously with the feeding process, without affecting the feeding process, saving a time and improving production efficiency thereof.

Referring to FIG. 7, the cutting unit 40 includes a rolling-cutting wheel 41 and a rolling-cutting blade 410 arranged on a circumferential surface of the rolling-cutting wheel 41 and perpendicular to an end surface of the rolling-cutting wheel 41. When the rolling-cutting wheel 41 rotates until the rolling-cutting blade 410 comes into contact with the buffer layer B1, as the rolling-cutting wheel 41 rotates, the rolling-cutting blade 410 cuts once every time as the rolling-cutting wheel 41 rolls one circle. The rolling-cutting blade 410 cuts the buffer layer B at a position perpendicular to the feeding direction, thereby forming the cushion unit B0.

Combined with FIG. 6, in particular, the buffer layer B is cut to be separated into the plurality of cushion units B0 arranged in a row from beginning to end. Each cushion unit B0 forms a first end x1 and a second end x2 in an order of being cut, that is to say, the cushion unit B0 includes the first end x1 and the second end x2 opposite to each other. The second end x2 of a previous cushion unit B0 is adjacent to the first end x1 of a current cushion unit B0. Each cushion unit B0 is sequentially fed from the first end x1 to the second end x2 to the paper pressing unit 30. The cushion unit B0 is pressed by both the paper pressing unit 30 the first sheet A1 to be fixed on the first sheet A1, or in other words, the paper pressing unit 30 presses against the cushion unit B0 and adheres the cushion unit B0 to the first sheet A1 during the rolling process.

The first unreeling unit 10 has the first feeding speed a, and the buffer layer feeding unit 20 has the changing feeding speed b. The changing feeding speed b includes a second feeding speed b1 and a third feeding speed b2, the third feeding speed b2 is the same as the first feeding speed a and the second feeding speed b1 is smaller than the first feeding speed a.

The first sheet A1 include an interval S that is formed between the first end x1 of the cushion unit B0 and the second end x2 of a previous cushion unit B0. It can also be understood that a plurality of intervals S is formed on the first sheet A1, each interval S arranged between the first end x1 of the current cushion unit B0 and the second end x2 of the previous cushion unit B0. The cutting unit 40 starts at the moment of cutting the buffer layer B1, that is, when cutting the first end x1 of the current cushion unit B0, at this time, both the first end x1 of the current cushion unit B0 and the second end x2 of the previous cushion unit B0 correspond to a starting position of the interval S. The buffer layer feeding unit 20 is continuously fed at the second feeding speed b1, which is smaller than the first feeding speed a, until the interval S is reserved on the first sheet A1. After this cutting, the previously cushion unit B0 that is cut is pressed and pasted onto the first sheet A1 by the paper pressing unit 30 to be fed at the first feeding speed a. Therefore, the second end x2 of the previous cushion unit B0 is naturally located at the starting position of the interval S of the first sheet A1 after the pressing is completed. The current cushion unit B0, which has just cut the first end x1, still needs to be fed along with the buffer layer feeding unit 20. The feeding speed of the current cushion unit B0 is the second feeding speed b1, which is smaller than the first feeding speed a. Therefore, the first end x1 of the current cushion unit B0 that is cut is fed slower than the first sheet A1, so that the current cushion unit B0 can reserve the interval S on the first sheet A1. Afterwards, when the reserved interval S reaches a preset width, such as 2 cm, the first end x1 of the current cushion unit B0 is fixed on the first sheet A1. From this time, the buffer layer feeding unit 20 continuously synchronizes with the first sheet A1 at the third feeding speed b2, which is the same as the first feeding speed a. Therefore, at this time, the second end x2 of the current cushion unit B0 is also located at the end position of the interval S after being pressed together. That is to say, after the buffer layer B1 is cut, the buffer layer feeding unit 20 is synchronously fed to the current cushion unit B0 at the third feeding speed b2 until the second end x2 of the current cushion unit B0 corresponds to the starting position of the interval S of the first sheet A1. Then, the cutting unit 40 rotates again to the cutting position to cut and separate the cushion unit B0. At this time, the first end x1 and the second end x2 of the previous cushion unit B0 are sequentially fixed on the first sheet A1 after passing through the paper pressing unit 30. Afterwards, the buffer layer feeding unit 20 is continuously fed at the second feeding speed b1, so that the interval S is reserved on the first sheet A1. And then, the feeding is continued according to the above feeding mode to produce the cushion sheet C1, which is fed back and forth in sequence.

Referring to FIG. 6, in an embodiment of the present disclosure, the buffer layer B1 includes a layer of pads B11, and a structure of the layer of pads B11 can be selected from at least one of a wavy corrugated paper structure, a concave convex structure, a plastic bubble film, and a three-dimensional hexagonal grid structure that is stretched by a slit paper.

In an embodiment of the present disclosure, the first unreeling unit 10 is configured to continuously unreel and feed at a fixed first feeding speed a, while the buffer layer B1 is fed at the changing speed b, and cooperates with the cutting unit 40 to cut at the position of the reserved interval S, so as to distribute the plurality of cushion units B0 arranged at intervals on the first sheet 10 and fed together with the first sheet 10 to the paper pressing unit 30. When making packaging bags, the cushion sheet C1 does not need to be heated and pressed at the interval S where the buffer layer B1 is not set on the first sheet 10, especially without pressing the buffer layer B1 into a flat structure, which can save a heating and pressing time. Only the cut cushion unit B0 needs to be guided along the feeding direction, connected or placed on the first sheet 10, and the cushion unit B0 can be arranged and fixed in rows on the continuous first sheet A1 at intervals.

Referring to FIG. 6, in the present disclosure, the cushion sheet production module 100 includes a first sizing glue unit 50 arranged in front of the paper pressing unit 30 along the feeding direction and configured to continuously apply the glue on a surface of the first sheet A1 facing the buffer layer B1 for pasting the first sheet A1 and the buffer layer B1 together. Of course, the position of the first sizing glue unit 50 can also be located on the surface of the buffer layer B1 facing the first sheet A1. Of course, the positions applied the glue by the first sizing glue unit 50 can also be on a surface of the buffer layer B1 facing the first sheet A1, or surfaces of the buffer layer B1 and the first sheet A1 that face to each other, as long as it can ensure that the first sheet A1 and the buffer layer B1 can be bonded and connected with each other. The positions that the first sizing glue unit 50 applies the glue can also be summarized as follows: the positions of the first sizing glue unit 50 for applying the glue are located on the first sheet A1 or the buffer layer B1, and are continuously or intermittently arranged along the feeding direction.

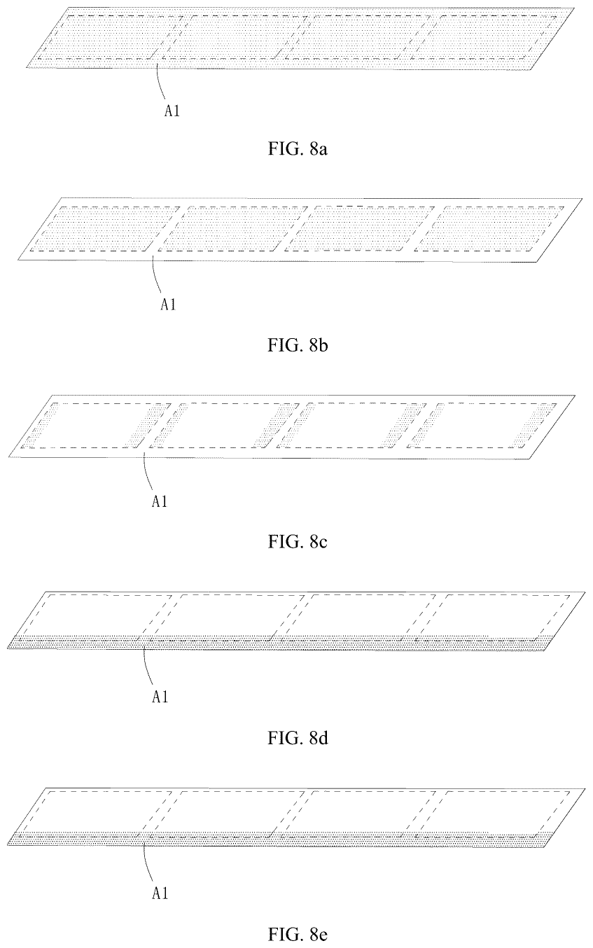

In the present disclosure, the first sizing glue unit 50 applies the glue along the feeding direction, that is, a first part to be fed should be applied the glue first, and a second part to be fed should be applied later, and a glue trajectory should follow the feeding direction; The glue is applied on at least one surface of the first sheet A1 or the surface of the buffer layer B1 that are opposite to each other. That is to say, the positions or the range of applying the glue can be on the surface of the first sheet A1 facing the buffer layer B1, and/or on the surface of the buffer layer B1 facing the first sheet A1. The positions or the range of applying the glue “along the feeding direction” includes any of the following:
A: the range of applying the glue is located on an entire surface of the first sheet A1 or the buffer layer B1, as shown in FIG. 8a.
B: the range of applying the glue is located on an entire area of the surface of the first sheet A1 or the buffer layer B1 that is corresponding to two adjacent intervals S, as shown in FIG. 8b.
C: the range of applying the glue is located on the surface of the first sheet A1 or the buffer layer B1 that is corresponding to two adjacent intervals S, and is a partial area of the surface between the two adjacent intervals S, as shown in FIG. 8c.
D: the range of applying the glue is located on one edge near the edges of the first sheet A1 or the buffer layer B1 along the feeding direction, as shown in FIG. 8d.
E: the range of applying the glue is located on two edges near the edges of the first sheet A1 or the buffer layer B1 along the feeding direction, as shown in FIG. 8e.

In the present disclosure, the position of applying the glue needs to be reasonably selected and verified based on structural characteristics of the pad B11 of the buffer layer B1 and the feeding speed.

For example, when the pad B11 is made of plastic bubble film, due to the softness and strong stretchability of the plastic bubble film itself, the first sizing glue unit 50 can apply the glue according to the above range A or B, and at this time, due to the stretchability and softness characteristics of the plastic bubble film, it is easy to paste between the two intervals S of the entire first sheet A1, which has no effect on the feeding speed and can maximize the feeding speed.

For example, when the pad B11 is made of a wavy corrugated paper structure, due to the relatively high hardness of the wavy corrugated paper and the uneven wavy surface, it is not suitable to use the range of applying the glue A as shown in FIG. 8a. Using the range A of applying the glue will inevitably reduce the feeding speed due to the large range of applying the glue. Therefore, the range of applying the glue C as shown in FIG. 8c or the range of applying the glue E as shown in FIG. 8e can be used for sizing glue. At this time, less glue is applied and it can improve the feeding speed, and only two opposite sides of the wavy corrugated paper structure need to be fixed. After fixing the two sides of the wavy corrugated paper structure, an area located in the middle of the two sides can ensure the integrity of the wave shape as much as possible without reducing the buffering performance thereof.

For example, when the pad B11 is a hexagonal grid structure, it can be applied the glue according to the range of applying the glue C as shown in FIG. 8c or the range of applying the glue e as shown in FIG. 8e. Two opposite sides of the hexagonal grid structure are fixed between two sides of the cushion sheet along the feeding direction or between two intervals S that are perpendicular to the feeding direction. At this point, on the one hand, it can prevent the middle area of the hexagonal grid structure from being fixed to the first sheet A1, for providing better cushioning performance; moreover, this method of only fixing the two ends can also prevent the hexagonal grid structure that is stretched from rebounding towards a state that is pre-stretched, which can improve the buffering performance of the hexagonal grid structure and also take into account the feeding speed.

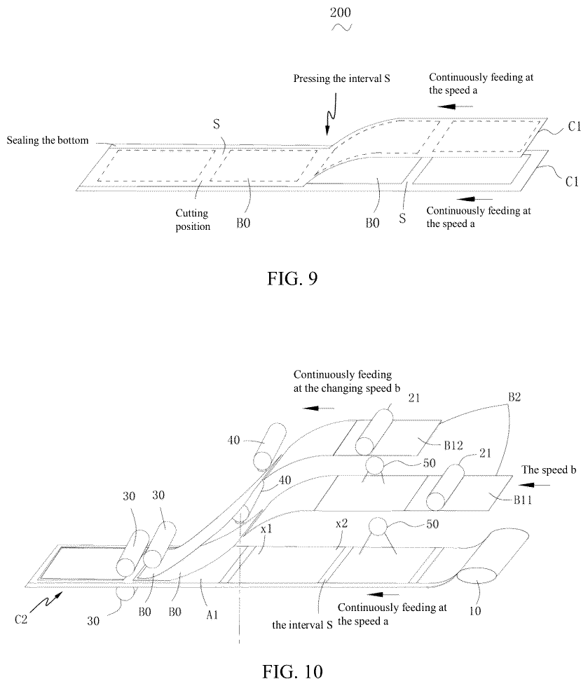

Referring to FIG. 9, When using the cushion sheet C1 of the first embodiment to produce the packaging bag 200, only two cushion sheet production modules 100 are needed to produce two cushion sheets C1. During synchronously and continuously feeding the two cushion sheets C1 along the same direction, the intervals S of the two cushion sheets C1 is aligned with each other and fixed at a position corresponding to the intervals S, the bottom edge is sealed, and the intervals S that are fixed are cut at the rear end of the feeding direction to form the packaging bag 200. The packaging bag 200 that is formed does not have the buffer layer B1 or the cushion unit B0 on both sides thereof, that is corresponding to the intervals S. Therefore, when fixing the sides (corresponding to the intervals S), there is no need for performing long-term compression or heating waiting, which can maximize production efficiency thereof. In addition, during the pressing process, it is not necessary to press against the entire cushion sheet C1 with the buffer layer B1 or the cushion unit B0. Only the side edges (corresponding to the intervals S) need to be pressed, which can prevent damage or reduction of the buffering performance of the buffer layer B1 or the cushion unit B0, and prevent the problem of reduced thickness and buffering performance of the cushion unit B0 due to an excessive pressure.

### A Second Embodiment of the Present Disclosure

Referring to FIG. 10, a difference between the second embodiment and the first embodiment is that: the buffer layer B2 includes two layers of pads (B11, B12), which are taken as a first pad B11 and a second pad B12, respectively. In an embodiment of the present disclosure, the buffer layer B2 may also include two or more layers of pads (B11, B12). The first pad B11 and the second pad B12 can be selected from at least one of a wavy corrugated paper structure, a concave convex structure, a plastic bubble film, and a three-dimensional hexagonal grid structure that is stretched by a slit paper.

That is to say, the first pad B11 and the second pad B12 can be the same, for example, both the first pad B11 and the second pad B12 are corrugated paper structures. The first pad B11 and the second pad B12 can also be different, for example, the first pad B11 is a wavy corrugated paper structure, while the second pad B12 is a plastic bubble film.

In an embodiment of the present disclosure, the buffer layer B2 has two layers of pads B11 and B12. The cushion sheet production module 100 includes a plurality of cutting units 40 and a plurality of first sizing glue units 50. The buffer layer feeding unit 20 includes a plurality of pad feeding units 21. Quantities of the plurality of pad feeding units 21, the plurality of first sizing glue units 50, and the plurality of cutting units 40 and the plurality of layers of pads (B11, B12) are the same. Each pad feeding unit 21 is configured to feed one layer of pad B11 or pad B12, at least one of the plurality of first sizing glue units 50 is configured to continuously apply the glue to the surface of one layer of pad B11 facing the other layer of pad B12, the positions that are applied the glue are set along the feeding direction. That is to say, the glue is applied to at least one surface of the pad B11 and the first sheet A1 that face to each other, as well as to at least one surface of the pad B12 and the pad B11 that face to each other, which can connect the first sheet A1, the pad B11, and the pad B12 to each other. Each cutting unit 40 is configured to cut a layer of pads (B11, B12). The two layers of pads B11 and B12 are stacked on top of each other and continuously fed synchronously, all at the changing feeding speeds b. After being cut, the two pad units B0 are also stacked on top of each other, for forming a multi-layer structure thereof.

When one layer of pads B11 is cut, positions that the layer of pads B11 is continuously applied the glue, are connected to the adjacent layer of pads B12.

In the embodiment, the positions of continuously applying the glue are the same as any of the range of applying the glues A-E of the first embodiment, which also needs to be selected according to the material of the pads (B11, B12) and feeding speed. The difference is that: when there are two layers of pads (B11, B12), at least one first sizing glue unit 50 needs to apply the glue to upper and lower surfaces of the pads (B11, B12) that are opposite to each other, so that the two pads (B11, B12) are connected to each other and fixed together as a whole with the first sheet A1.

In the embodiment, without reducing the first feeding speed a of the first embodiment, it is possible to produce the cushion sheet C2 with a multi-layer cushion structure during the feeding process, which can make the cushion sheet C2 have a better buffering effect compared to the cushion sheet C1 of the first embodiment.

### A Third Embodiment of the Present Disclosure

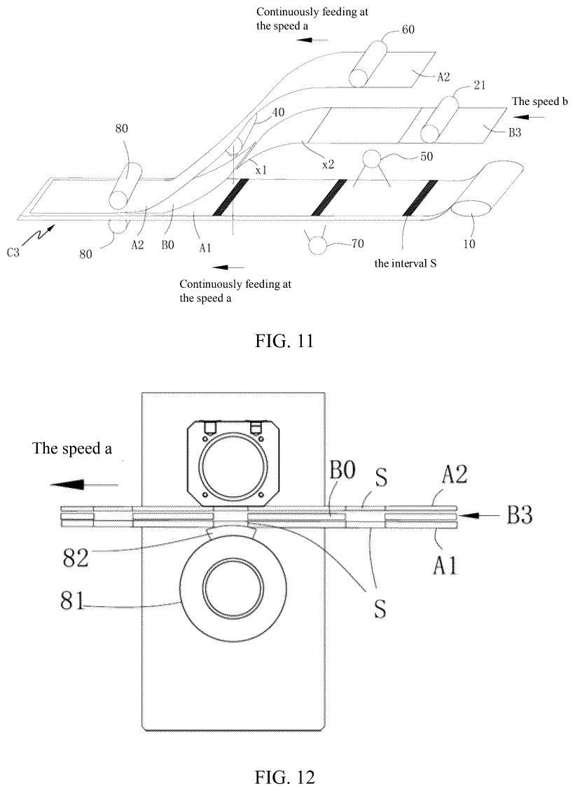

Referring to FIG. 11, based on the first embodiment or the second embodiment, the cushion sheet production module 100 of the third embodiment further includes: a second unreeling unit 60, a second sizing glue unit 70 and a rolling-pressing unit 80.

The second unreeling unit 60 is arranged in front of the paper pressing unit 30 along the feeding direction and configured to unreel the second sheet A2 along the feeding direction. The first sheet A1 and the second sheet A2 are fed synchronously and continuously. The buffer layer B3 of the third embodiment is the buffer layer B1 of the first embodiment or the buffer layer B2 of the second embodiment. In the third embodiment, the buffer layer B3 is arranged between the first sheet A1 and the second sheet A2.

The second sizing glue unit 70 is arranged in front of the rolling-pressing unit 80 along the feeding direction, and positions of applying the glue by the second sizing glue unit 70 is: x) on a surface of the second sheet A2 facing the first sheet A1, and corresponding to the intervals S of the first sheet A1, or y) on a surface of the first sheet A1 facing the second sheet A2, and corresponding to the intervals S of the first sheet A1.

The rolling-pressing unit 80 is arranged behind the second unreeling unit 70 along the feeding direction and configured to roll and press against the plurality of intervals S of the first sheet A1, and positions of the second sheet A2 that correspond to the plurality of intervals S, for fixing the first sheet A1 and the second sheet A2 in a direction perpendicular to the feeding direction, each of the plurality of cushion units B0 arranged between two adjacent intervals S and wrapped by both the first sheet A1 and the second sheet A2.

The second sizing glue unit 70 is also configured to continuously apply the glue on the surface of the second sheet A2 facing the first sheet A1, to connect two edges of the first sheet A1 and the second sheet A2 along the feeding direction. The positions of applying the glue by the second sizing glue unit 70 can be the same as at least one of the glue positions A-E of the first embodiment or can also be at positions corresponding to the intervals S. At this time, the rolling-pressing unit 80 is configured to roll and press against the positions of the first sheet A1 and the second sheet A2 relative to each other for fixing the first sheet A1 and the second sheet A2 together. That is to say, the first sizing glue unit 50 applies the glue to paste the first sheet A1 and the buffer layer (B1, B2, B3), while the second sizing glue unit 70 applies the glue to paste the first sheet A1 and the second sheet A2.

In the third embodiment, that is, the second sizing glue unit 70 can apply the glue at different positions to fix the first sheet A1 and the second sheet A2 according to different fixing methods and positions. One way is to fix the first sheet A1 and the second sheet A2 to each other at the intervals S or at positions of the first sheet A that are corresponding to the intervals S of the first sheet A1, and the buffer layer B3 is located between adjacent intervals S. Another way is to fix the first sheet A1 and the second sheet A2 near at least one edge thereof along the feeding direction, that is, the range of applying the glue D of FIG. 8d or the range of applying the glue E of FIG. 8e, and the buffer layer 3B is also wrapped between adjacent intervals S. In this embodiment, how to fix the first sheet A1 and the second sheet A2 can be determined based on the material of the buffer layer B3 that is selected and the number of pads (B11, B12) of the buffer layer B3.

In the third embodiment of the present disclosure, the cushion sheet C3 is a three-layer or more structure sandwiched by the first sheet A1, the buffer layer B3 and the second sheet A2. The buffer layer B3 can be set to one layer or two layers or more layers of pads depending on the number of pads. In this embodiment, compared to the first and second embodiments, the second sheet A2 is added. The cushion sheet C3 is made by sandwiching the buffer layer B3 between the first sheet A1 and the second sheet A2, which can improve the wear resistance of the cushion sheet C1 of the first embodiment or the cushion sheet C2 of the second embodiment. At the same time, it can also make the cushion sheet C3 look more beautiful and flat, which is conducive to using the cushion sheet C3 to produce the packaging bag.

Referring to FIG. 12, in the present disclosure, the rolling-pressing unit 80 includes: at least group of paper pressing rollers 81 that are provided with paper pressing bosses 82. The paper pressing bosses 82 are perpendicular to the feeding direction and extend outwardly from the outer circumference of the paper pressing rollers 81. When the paper pressing rollers 81 rotate, the paper pressing bosses 82 are configured to press and fix the first sheet A1, the buffer layer B3 or the cushion unit B0, and the second sheet A2 by only pressing against at the intervals S and positions of the first sheet A1 that are corresponding to the intervals S, so that the buffer layer B3 or the cushion unit B0 between adjacent intervals S is still in a three-dimensional grid structure, and is not pressed to affect the buffering performance. That is to say, every rotation of the paper pressing rollers 81 corresponds to one press fit, and a circumference of the paper pressing rollers 81 that rotate for a circle is a length between two adjacent intervals S.

### A Fourth Embodiment of the Present Disclosure

In the fourth embodiment of the present disclosure, the cushion sheet production module 100 is improved based on the first embodiment to produce the cushion sheet C4.

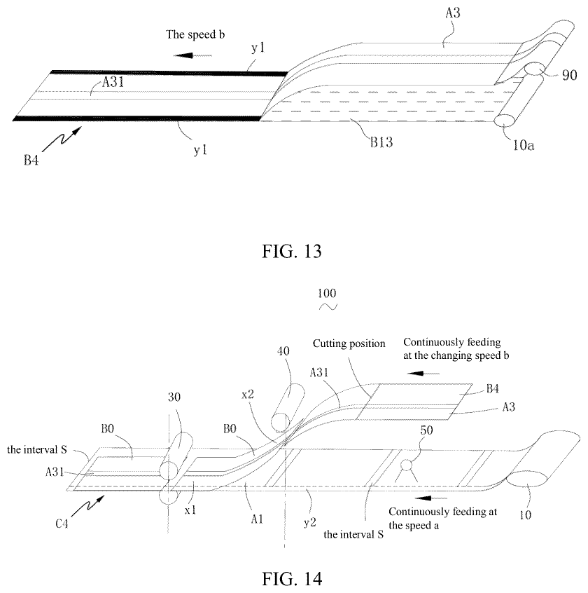

Referring to FIG. 13, the buffer layer B4 of the fourth embodiment includes a slit paper B13 that is unstretched and a third sheet A3, that is, the slit paper B13 and the third sheet A3 together form the buffer layer B1 of the first embodiment.

Compared with the first embodiment, the buffer layer feeding unit 20 of the fourth embodiment further includes a third unreeling unit 90 and a slit paper unreeling unit 10a.

Specifically, the third unreeling unit 90 is configured to unreel a third sheet A3 at a speed along the feeding direction to make the third sheet A3 to be continuously fed along the feeding direction, the third sheet A3 is provided with a plurality of wrinkles A31 extending along the feeding direction. The plurality of wrinkles A31 is unreeled along with the third sheet A3 and is in an unstretched state; the slit paper unreeling unit 10a is configured to unreel a slit paper B13 along the feeding direction to make the slit paper B13 to be continuously fed along the feeding direction, the slit paper B13 arranged between the first sheet A1 and the third sheet A3.

Both the slit paper B13 and the third sheet A3 are unreeled synchronously, and two edges y1 of the slit paper B13 and two edges Y1 of the third sheet a3 along the feeding direction are connected to each other after being glued by the first sizing glue unit 50. The slit paper B13 and the third sheet A3 are connected to each other at the two side edges y1, which can be pre-set with the glue to be connected or set with the glue during the feeding process and then connected.

The buffer layer B4 of the fourth embodiment is different from the buffer layer of the first embodiment. Specifically, as shown in FIG. 14, the buffer layer B4 of the fourth embodiment is formed by connecting the slit paper B13 and the third sheet A3. The glue applied by the first sizing glue unit 50 of the fourth embodiment is only located on surfaces of the first sheet A1 or the buffer layer B4 that face each other, and along one side edge y2 of the feeding direction, thereby connecting the buffer layer B4 on the one side edge y2 of the first sheet A1, instead of the range of applying the glue A-C similar to that of the first embodiment. That is to say, in the fourth embodiment, the first sizing glue unit 50 applies the glue according to the range of applying the glue D of the first embodiment, and corresponding to the method shown in FIG. 8d.

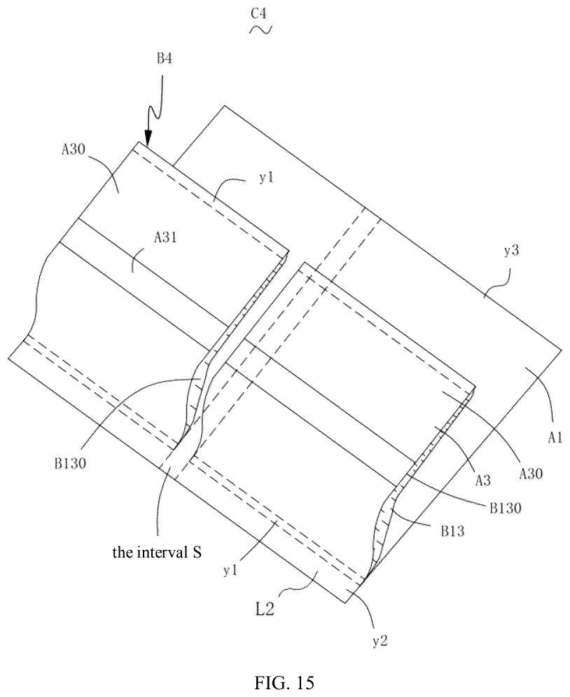

Referring to FIG. 14 and FIG. 15, after the first sheet A1 is connected with the buffer layer B4, the cushion sheet C4 is formed and fixed at one side edge y2 in the feeding direction, and the other side edge y3 in the feeding direction is in a separated state and not connected.

Each of a width of the slit paper B3 perpendicular to the feeding direction and a width of the third sheet A3 perpendicular to the feeding direction is smaller than a width of the first sheet A1 perpendicular to the feeding direction. When the third sheet A3 moves towards the other side edge y3 of the first sheet A1, the plurality of wrinkles A31 of the third sheet A3 are unfolded, and at the same time, the slit paper B13 connected to the third sheet A3 is moved, thereby causing the slit paper B13 to be stretched. The slit paper B13 that is stretched forms a three-dimensional grid structure, thus having buffering performance thereof.

The cushion sheet C4 has a planar structure before the slit paper B13 is unstretched. When the slit paper B13 in the middle of the cushion sheet C4 is stretched, a thickness increases. Therefore, the cushion sheet C4 of the fourth embodiment is a planar structure during transportation and storage, which can reduce transportation costs. When in use, the slit paper B13 can be stretched by pushing the third sheet A3, thereby causing the cushion sheet C4 to become a three-dimensional structure for buffering and wrapping items thereof.

In addition, the cushion sheet C4 of the fourth embodiment can also be used to produce packaging bags.

Compared to the first embodiment, another difference of the fourth embodiment is that: the cutting unit 30 is arranged between the paper pressing unit 40 and the slit paper feeding unit 10a, and configured to cut the slit paper B13 and the third sheet A3 during the feeding process.

The cutting unit 30 still adopts a rolling cutting method as in the first embodiment, with the cutting positions of the slit paper B13 and the third sheet A3 corresponding to each other. The cutting positions are spaced apart on the slit paper B13 and the third sheet A3, and are perpendicular to the feeding direction.

Referring to FIG. 15, the slit paper B13 is cut to be separated into a plurality of slit paper units B130 sequentially arranged in a row from beginning to end, the third sheet A3 is cut to be separated into a plurality of third sheet units A30 sequentially arranged in a row from beginning to end, each slit paper unit B130 corresponds one-to-one with each third sheet unit A30 to form the cushion unit B0.

Thus, the cushion unit B0 of the fourth embodiment is fed according to a similar feeding method as the buffer layer B1 of the first embodiment, with the changing feeding speed b, as well as cutting, rolling and pressing, to obtain the cushion sheet C4 of the fourth embodiment. That is to say, both the slit paper unreeling unit 10a and the third unreeling unit 90 are fed along the feeding direction at the changing feeding speeds b, while the first unreeling unit 10 is fed at the first feeding speed a.

### A Fifth Embodiment of the Present Disclosure

In the fifth embodiment of the present disclosure, the cushion sheet production module 100 is improved based on the fourth embodiment to produce the cushion sheet C5.

Referring to FIG. 16, a difference between the cushion sheet C5 that is produced according to the fifth embodiment and the cushion sheet C4 of the fourth embodiment is only the buffer layer B5. The difference of the buffer layer B5 is that: the third sheet A3 is not provided with the wrinkles A31, and the third sheet A3 is only connected to the slit paper B13 at one side edge y12 thereof along the feeding direction. The range of applying the glue of the first sizing glue unit 50 is shown in FIG. 8e, which is the range of applying the glue E of the first embodiment. The other side edge of the third sheet A3 along the feeding direction is not connected to the slit paper B13. At the same time, the cushion sheet C5 also includes a fourth sheet A4, which is only connected to the other side edge y11 of the slit paper B13 along the feeding direction, and the other side of the fourth sheet A4 along the feeding direction is not connected to the slit paper B13. The side of the third sheet A3 that is not connected to the slit paper B13, and the side of the fourth sheet A4 that is not connected to the slit paper B13 are stacked and not connected to each other, for forming an overlapping area Z thereof.

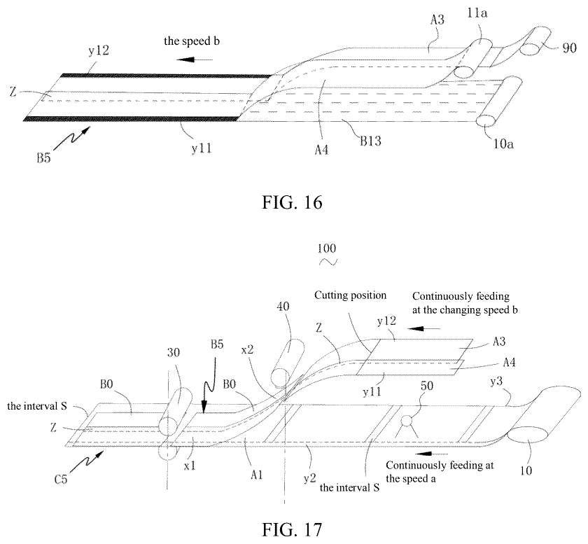

Referring to FIG. 17, in the fifth embodiment of the present disclosure, when cutting by the cutting unit 40, the cutting unit 40 rolls and cuts at corresponding positions of the slit paper B13, the third sheet A3, and the fourth sheet A4. The positions of rolling and cutting are set on the slit paper B13, the third sheet A3 and the fourth sheet A4 at intervals along the feeding direction, and are perpendicular to the feeding direction. Moreover, all of the slit paper B13, the third sheet A3 and the fourth sheet A4 are fed continuously and synchronously, with the changing feeding speed b of first to fourth embodiments, which can ensure that the intervals S can still be formed on the first sheet A1 as in the first to fourth embodiments.

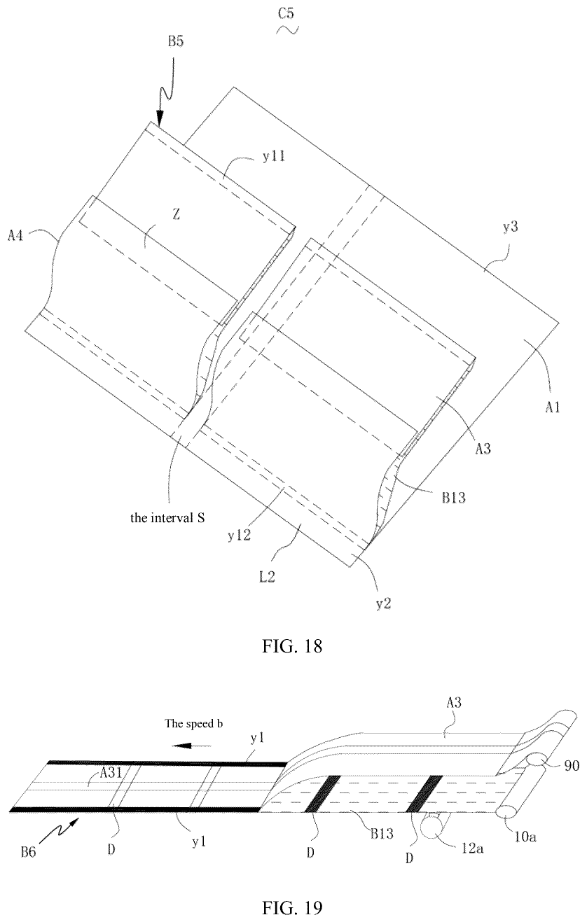

Referring to FIG. 18, when the third sheet A3 moves towards the other side y3 of the first sheet A1, the overlapping area Z is unfolded, and at the same time, it drives the slit paper B13 that is connected to the third sheet A3 to move, thereby stretching the slit paper B13. The slit paper B13 that is stretched is to form a three-dimensional grid structure, thereby having buffering performance thereof.

Before stretching the slit paper B13, the cushion sheet C5 is a planar structure. When the slit paper B13 in the middle of the cushion sheet C5 is stretched, the thickness increases. Therefore, the cushion sheet C5 of the fifth embodiment is a planar structure during transportation and storage, which can reduce transportation costs. When in use, the slit paper B13 can be stretched by pushing the third sheet A3, thereby becoming a three-dimensional structure for cushioning and wrapping items.

In addition, the cushion sheet C5 of the fifth embodiment can also be used to produce packaging bags.

Therefore, as shown in FIG. 16, the cushion sheet production module 100 of the fifth embodiment further includes a fourth unreeling unit 11a configured to unreel the fourth sheet A4 along the feeding direction. The fourth sheet A4 partially overlaps with the third sheet A3, for forming the overlapping area Z. The overlapping area Z is unreeled synchronously with both the third sheet A3 and the fourth sheet A4. A width that the unreeled third sheet A3 and the fourth sheet A4 are overlapped along a direction perpendicular to the feeding direction is smaller than a width of the first sheet A1 along a direction perpendicular to the feeding direction. The slit paper B13 is also in an unstretched state, one side edge y12 of the third sheet A3 along the feeding direction and one side edge y11 of the fourth sheet A4 along the feeding direction are fixed with each other. At the same time, the first sizing glue unit 50 still applies the glue to the first sheet A1 or the slit paper A13 in the way of the range of applying the glue D of the first embodiment, so that the slit paper and the first sheet A1 are only connected at one side edge y2 along an extension direction thereof.

### A Sixth Embodiment of the Present Disclosure

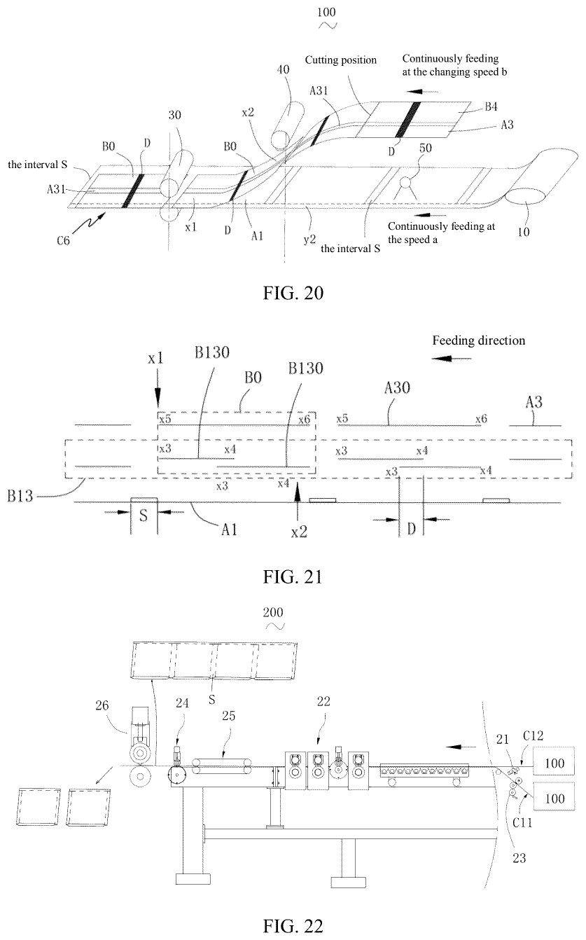

Referring to FIG. 19 to FIG. 21, the sixth embodiment has been improved based on the fourth embodiment or the fifth embodiment, and a difference from the fourth embodiment or the fifth embodiment is that: the cushion sheet production module 100 is configured to produce the cushion sheet C6, and the cushion sheet production module 100 also includes a slit paper cutting unit 12a. Taking the fourth embodiment with only the third sheet A3 above the slit paper B13 as an example, the difference between the sixth embodiment and the fourth embodiment is that: the speed of the third unreeling unit 90 includes the second feeding speed b1 and the third feeding speed b2, while the slit paper unreeling unit 10a includes the second feeding speed b1, a third feeding speed b2 and a fourth feeding speed b3.

In the sixth embodiment of the present disclosure, the cutting unit 40 is arranged behind the paper pressing unit 30 along the feeding direction and between the paper pressing unit 30 and the slit paper feeding unit 10a, the cutting unit 40 configured to roll and cut the third sheet A3 during feeding the third sheet A3, cutting positions of the third sheet A3 arranged on the third sheet A3 at intervals and perpendicular to the feeding direction. The slit paper cutting unit 12a is arranged between the cutting unit 40 and the slit paper unreeling unit 10a, and configured to cut the slit paper B13.

Referring to FIG. 21, the slit paper B13 is cut to be separated into a plurality of slit paper units B130 sequentially arranged in a row from beginning to end, the third sheet A3 is cut to be separated into a plurality of third sheet units A30 sequentially arranged in a row from beginning to end, each adjacent two slit paper units B130 connected to one of the plurality of third sheet units A30, to form a corresponding cushion unit B0 vertically.

There is a plurality of cushion units B0 arranged in a row from beginning to end, each of the plurality of cushion units B0 including a first end x1 and a second end x2 arranged along the feeding direction and opposite to each other, the second end x2 of a previous cushion unit B0 adjacent to the first end x1 of a current cushion unit B0; and wherein each cushion unit B0 is sequentially fed to the paper pressing unit 30 from the first end x1 to the second end x2, and the plurality of cushion units B0 are fixed on the first sheet A1 after the plurality of cushion units B0 is pressed against by the paper pressing unit 30.

Each of the plurality of slit paper units B130 includes a third end x3 and a fourth end x4 opposite to each other along the feeding direction, and in the same cushion unit B0, the fourth end x4 of a current slit paper unit B130 corresponding to the second end x2 of the cushion unit B0, and the third end x3 of a previous slit paper unit B130 corresponding to the first end x1 of the cushion unit B0.

Each of the plurality of third sheet units A30 includes a fifth end x5 and a sixth end x6 opposite to each other along the feeding direction, and in the same cushion unit B0, the fifth end x5 of a current third sheet unit A30 corresponding to the first end x1 of the cushion unit B0, and the sixth end x6 of a next third sheet unit A30 corresponding to the second end x2 of the cushion unit B0.

A plurality of intervals S is formed on the first sheet A1, each of the plurality of intervals S arranged between the first end x1 of the current cushion unit B0 and the second end x2 of the previous cushion unit B0, the plurality of intervals S arranged along a direction perpendicular to the feeding direction, and arranged along the feeding direction of the first sheet A1 at intervals.

The slit paper unreeling unit 10a has a changing feeding speed b, wherein the changing speed b includes a second feeding speed b1, a third feeding speed b2 and a fourth feeding speed b3, the third feeding speed b2 equal to the first feeding speed a, the second feeding speed b1 smaller than the first feeding speed a, and the fourth feeding speed b3 greater than the first feeding speed a.

The speed of the third unreeling unit 90 includes the second feeding speed B1 and the third feeding speed Bb.

When the fifth end x5 of the current third sheet unit A30 corresponds to an end position of the interval S of the first sheet A1, the third unreeling unit 90 feeds the third sheet A3 at the third feeding speed b2, so that the third sheet A3 is fed synchronously with the first sheet A1; and when the sixth end x6 of the current third sheet unit A30 corresponds to a starting position of the interval S of the first sheet A1, the third unreeling unit 90 feeds the third sheet A3 at the second feeding speed b1 until the fifth end x5 of the next third sheet unit A30 corresponds to the starting position of an adjacent interval S of the first sheet A1.

When the third end x3 of the previous slit paper unit B130 corresponds to the end position of the interval S of the first sheet A1, the slit paper unreeling unit 12a feeds the slit paper B13 at the third feeding speed b2, so that the slit paper B13 is synchronously fed with the first sheet A1 and the third sheet A3; and when the fourth end x4 of the previous slit paper unit B130 is fed to a predetermined position between two adjacent intervals S of the first sheet A1, the slit paper unreeling unit 12a feeds the slit paper B13 at the fourth feeding speed b3, and the third end x3 of the current slit paper unit B130 that is fed at the fourth feeding speed b3 is overlapped with the fourth end x4 of the previous slit paper unit B130. When the third end x3 of the current slit paper unit B130 is overlapped with the fourth end x4 of the previous slit paper unit B130 by a predetermined width, the slit paper unreeling unit 12a continues to feed the slit paper B130 at the third feeding speed b1 until the fourth end x4 of the current slit paper unit B130 is located at the starting position of the adjacent interval S, at this time, the slit paper unreeling unit 12a feeds the slit paper B130 at the second feeding speed b1 until the third end x3 of the next slit paper unit B130 corresponds to the ending position of the adjacent interval S.

In the sixth embodiment of the present disclosure, when the fourth sheet A4 of the fifth embodiment is also included in the sixth embodiment, the fourth sheet A4 is fed synchronously with the third sheet A3. When cutting the third sheet A3, the cutting unit 30 can synchronously cut the fourth sheet A4 at the positions of the fourth sheet A4 that are corresponding to the third sheet A3, thus forming the plurality of cushion units B0 with the slit paper B13, the third sheet A3, and the fourth sheet A4. After the plurality of cushion units B0 is connected to the first sheet A1, the cushion sheet C6 is formed.

In the sixth embodiment of the present disclosure, because the slit paper B13 with an unstretched state is fixed on the third sheet A3 and/or the fourth sheet A4, when the slit paper B13 is stretched along a direction perpendicular to the feeding direction, a three-dimensional grid structure is formed. A length that is perpendicular to the feeding direction will increase, but the width of the slit paper B13 along the feeding direction will decrease, that is, the width along a stretching direction of the cushion unit B0 will decrease, thereby resulting in partial areas on both sides of the cushion unit B0 from being unable to obtain buffer protection thereof. When two slit papers B13 that are stacked with each other are used to produce the cushion unit B0, even if the slit paper B13 is stretched into the three-dimensional grid structure, it can minimize the loss in the width direction as much as possible, for ensuring that the cushion unit B0 can cover the maximum area and improve the buffering performance thereof.

A packaging bag production device 200 of the present disclosure is provided and includes two embodiments.

### A First Embodiment of the Present Disclosure

Referring to FIG. 22, the packaging bag production device 200 of the first embodiment includes two cushion sheet production modules 100, and the two cushion sheet production modules 100 of the first embodiment is adopted any one of the cushion sheet production module of the first embodiment to the third embodiment. The cushion production module 100 of the embodiment is used to produce at least one type of cushion sheet (C1, C2, C3) from the first embodiment to the third embodiment above mentioned. The cushion sheets (C1, C2, C3) produced by the two cushion sheet production modules 100 are taken as a first cushion sheet C11 and a second cushion sheet C12, respectively. The first cushion sheet C11 and the second cushion sheet C12 are arranged opposite to each other and fed Synchronously.

The term “opposite to each other or facing each other” means that the first sheet A1 of the first cushion sheet C11 and the first sheet A1 of the second cushion sheet C12 are arranged on the outer side thereof, while the cushion unit B0 of the first cushion sheet C11 and the cushion unit B0 of the second cushion sheet C12 are positioned between the first sheet A1 of the first cushion sheet C11 and the first sheet A1 of the second cushion sheet C12, thereby ensuring that an outer surface of the packaging bag 300 is formed by the first sheet A1, with the cushion unit B0 being arranged inside the packaging bag 300.

In the packaging bag production device 200 of the first embodiment of the present disclosure, A structure of the first cushion sheet C11 is the same as that of the second cushion sheet C12. The first sheet A1 of the first cushion sheet 11 and the first sheet A1 of the second cushion sheet C12 are arranged on the upper side and the lower side of the buffer layers (B1, B2, B3) of the first cushion sheet C11 and the second cushion sheet C12. Or in other words, the first sheet A1 of the first cushion sheet C11 is located above the buffer layer B1 of the first cushion sheet C11, the buffer layer B1 of the first cushion sheet C11 is located above the buffer layer B1 of the second cushion sheet C12, and the first sheet A1 of the second cushion sheet C12 is located below the buffer layer B1 of the second cushion sheet C12.

In order to further illustrate a positional relationship between the first cushion sheet C11 and the second cushion sheet C12, in the embodiment, the first sheets A1 of the first cushion sheet C11 and the second cushion sheet C12 has the plurality of intervals S as described in the above mentioned first to third embodiments.

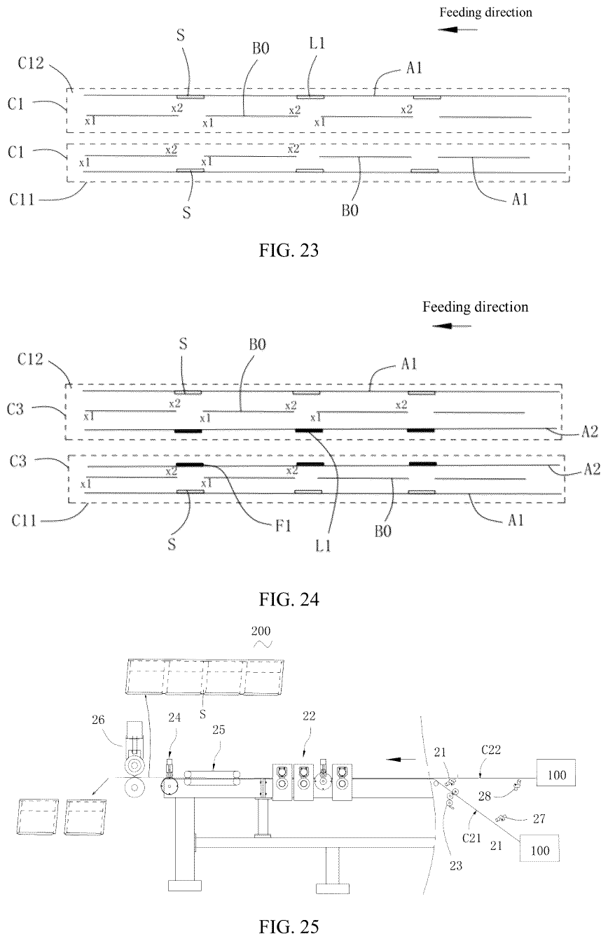

Referring to FIG. 23, the following description will take the first cushion sheet C11 and the second cushion sheet C12 as examples of the cushion sheet C1 of the first embodiment above mentioned.

The packaging bag production device 200 further includes:
a first bag gluing unit 21 arranged behind the first unreeling unit 10 along the feeding direction and configured to apply glue on at least one surface of the first cushion sheet C11 and the second cushion sheet C12 that are opposite to each other, first positions L1 of the first cushion sheet C11 and/or the second cushion sheet C12 that the glue is applied by the first bag gluing unit 21 arranged at intervals, and a direction of the first positions L1 that are applied the glue perpendicular to the feeding direction. The first positions L1 are arranged on the plurality of intervals S of the first cushion sheet C11 or the second cushion sheet C12, and the buffer layers (B1, B2, B3) of the first cushion sheet C11 that are relative to the buffer layers (B1, B2, B3) of the second cushion sheet C12.

A first bag pressing unit 22 arranged behind the first bag gluing unit 21 along the feeding direction and configured to roll and press against the first positions L1, that is to roll and press against the plurality of intervals S of the first cushion sheet C11 or the second cushion sheet C12, so that the first cushion sheet C11 and the second cushion sheet C12 are connected with each other at the first positions L1 thereof, to form two sides of a packaging bag.

In this embodiment, since the cushion unit B0 is not set on the interval S, when being rolled and pressed, the intervals S of the first sheet A1 in the first cushion sheet C11 and the intervals S of the first sheet A1 in the second cushion sheet C12 can be directly aligned with each other and connected, thereby reducing the time required for pressing and heating the buffer layer B0 of the related art.

Referring to FIG. 24, the first cushion sheet C11 and the second cushion sheet C12 of this embodiment can also be the cushion sheet C3 of the third embodiment above mentioned, taking the cushion sheet C3 of the above third embodiment as an example for further description. A difference between the cushion sheet C3 and the cushion sheet C1 is that: the cushion sheet C3 also includes the second sheet A2, and the buffer layer B3 is arranged between the first sheet A1 and the second sheet A2.

A difference between the example of FIG. 24 and the example of FIG. 23 is that both the first cushion sheet C11 and the second cushion sheet C12 are the cushion sheets C1. The cushion sheet C1 is formed by a layer of first sheet A1 and a cushion unit B0 spaced apart from each other. Therefore, the glue is applied on the surface of the first cushion sheet C11 that faces the second cushion sheet C12, and the glue is set at positions corresponding to the intervals S, that is, the first positions L1 is arranged at the intervals S on the first cushion sheet C11 or the second cushion sheet C12.

In this example, since each of the first cushion sheet C11 and the second cushion sheet C12 is a three-layer cushion sheet C3, which has the second sheet A2. In this way, the second sheet A2 is provided with a plurality of lateral positions F1 corresponding one-to-one with the plurality of intervals S, the plurality of lateral positions F1 arranged on the surface of the first cushion sheet C11 facing the second cushion sheet C12, or on the surface of the second cushion sheet C12 facing the first cushion sheet C11, and arranged between the first end x1 of the current cushion unit B0 and the second end x2 of the previous cushion unit B0 of the cushion sheet C3. At this time, the positions that the first bag gluing unit 21 applies the glue is not the intervals S, but positions on the first cushion sheet C11 or the second cushion sheet C12 that correspond to the intervals S, that is, the lateral position F1. Due to the glue applied on the lateral positions F1, the first cushion sheet C11 and the second cushion sheet C12 can be connected to form the sides of the packaging bag. At this time, on the sides of the packaging bag, the first sheet A1 of the first cushion sheet C11 is connected to the second sheet A2 of the first cushion sheet C11, the second sheet A2 of the first cushion sheet C11 is connected to the second sheet A2 of the second cushion sheet C12, and the second sheet A2 of the second cushion sheet C12 is connected to the first sheet A1 of the second cushion sheet C12, thereby ensuring that each individual cushion sheet (C11, C12) does not have the cushion unit B0 at the sides of the packaging bag to be connected. And the two cushion sheets (C11, C12) are also connected to each other at the sides of the packaging bag.

Referring to FIG. 22, the packaging bag production device 200 further includes a second bag gluing unit 23 and a second bag pressing unit 24.

The second bag gluing unit 23 is arranged behind the first unreeling unit 10 along the feeding direction and configured to apply the glue on at least one surface of the first cushion sheet C11 or the second cushion sheet C12 that are opposite to each other, positions that the glue is applied by the second bag gluing unit 23 is taken as a second position L2 continuous arranged along the feeding direction and arranged at a lateral edge along the feeding direction relative to the first cushion sheet C11. The second position L2 corresponds to the edge y2 of FIG. 15 and FIG. 18. The second bag pressing unit 24 is located behind the second bag gluing unit 23 along the feeding direction and configured to roll and press against the first cushion sheet C11 and the second cushion sheet C12, and to press and stick the first cushion sheet C11 and the second cushion sheet C12 to each other at the second positions L2, thereby forming the bottom of the packaging bag.

In the first embodiment of the present disclosure, the first bag pressing unit 22 only presses the positions of the first cushion sheet C11 and the second cushion sheet C12 relative to the intervals S or the lateral positions F1, that is, the first positions L1, to form the side of the packaging bag 300. However, there are buffer layer (B1, B2, B3) arranged on the sides of the packaging bag 300, so there is no need for preheating or a long pressing time during the pressing process, which can maximize the first feeding speed a of the cushion sheet production module, thereby improving production efficiency thereof. In addition, the packaging bag production device 200 can also be compatible with multiple structures of buffer layers (B1, B2, B3), thereby producing a variety of packaging bags 300 with different structures.

In the first embodiment, the second bag pressing unit 24 can directly press against the first cushion sheet C11 and the second cushion sheet C12 on one side edge along the feeding direction to fix the first cushion sheet C11 and the second cushion sheet C12, that is, press against the second position L2 to form the bottom of the packaging bag 300, rather than pressing or applying the glue on the other side edge to form the pocket of the packaging bag 300. The packaging bag 300 that is produced is to form the side edge of the packaging bag 300 at the intervals S and the lateral positions F1, and form the bottom of the packaging bag 300 on one side edge along the feeding direction. The first bag gluing unit 21, the first bag pressing unit 22, the second bag gluing unit 23, and the second bag pressing unit 24 all work during feeding the first cushion sheet C11 and the second cushion sheet C12, and both the first cushion sheet C11 and the second cushion sheet C12 are also in a continuous and uninterrupted feeding process during production thereof. When feeding the first sheet A1, the second sheet A2, the buffer layers B1, B2, B3, and the slit paper B13, the first cushion sheet C11 and the second cushion sheet C12 are produced while both the first cushion sheet C11 and the second cushion sheet C12 are continuously fed without interruption. At the same time, the first cushion sheet C11 and the second cushion sheet C12 are used to simultaneously produce the packaging bag 300, which can maximize production efficiency thereof.

In the first embodiment, the bottom of the packaging bag 300 can be made by another way. Specifically, the packaging bag production device 200 also includes:
a bottom flipping unit 25 is arranged at the rear end of the second bag gluing unit 23 along the feeding direction, and located between the second bag gluing unit 23 and the second bag pressing unit 24. The bottom flipping unit 25 is configured to flip the positions of the first cushion sheet C11 that the glue is applied by the second bag gluing unit 23 to wrap the edge of another second sheet C12, or to flip the positions of the second cushion sheet C12 that the glue is applied by the second bag gluing unit 23 to wrap another first cushion sheet C11. The second bag pressing unit 24 is configured to press against the first sheet C11 and/or the second sheet C12 at the folding positions to form the bottom of the packaging bag 300.

That is to say, the bottom of the packaging bag 300 is not directly pressed by the first cushion sheet C11 and the second cushion sheet C12 at the one side along the feeding direction. Instead, the first cushion sheet C11 or the second cushion sheet C12 is glued at the opposite side and then folded, the first cushion sheet C11 is wrapped around the second cushion sheet C12 or the second cushion sheet C12 is wrapped around the first sheet C11 before being pressed together. Compared to a method of directly pressing against the side edges of the first cushion sheet C11 and the second cushion sheet C12 without being folded to form the bottom of the packaging bag 300, this method of the first embodiment can provide a deeper insertion depth for the packaging bag 300 and increase an internal space of the packaging bag 300.

In the first embodiment of the present disclosure, the packaging bag production device 200 further includes a bag cutting edge unit 26 arranged behind the second bag pressing unit 22 along the feeding direction and configured to cut the packaging bag 300 that is pressed to be formed along a direction perpendicular to the feeding direction. Positions that are cut are located on the sides of two adjacent packaging bags 300, that is, at the positions of each interval S or each lateral position F1, that is, the first position L1. In this embodiment, the bag cutting edge unit 26 also adopts a rolling cutting method, which only contacts the packaging bag 300 at the interval S or the lateral position F1, thereby avoiding affecting the buffer layers (B1, B2, B3) between the two intervals S and reducing the buffering effect thereof. In addition, the rolling cutting method can also be used in conjunction with the feeding speed of the first cushion sheet C11 or the second cushion sheet C12 to achieve a high-speed cutting and improve production efficiency thereof.

In this embodiment, each of the first bag pressing unit 22 and the second bag pressing unit 24 has a similar structure to the rolling-pressing unit 80 of the above second embodiment as shown in FIG. 12, and the bag cutting edge unit 26 has a similar structure to the cutting unit 40 of the above first embodiment as shown in FIG. 7, which are to use rolling-pressing and rolling-cutting methods.

The feeding speed of the first cushion sheet C11 and the second cushion sheet C12 is the same as that of the first sheet A1 of the above cushion sheet production module 100, which are the first feeding speed a. That is to say, in the packaging bag production device 200, during producing and feeding the buffer layers (B1, B2, B3), it is carried out according to the changing feeding speed b. When feeding the first sheet A1 and the second sheet A2, the first feeding speed a is followed. At the same time, the entire cushion sheet production module 100 and the packaging bag production device 200 with two cushion sheet production modules 100 are completed on the same machine. The entire machine can complete the production of packaging bag 300 by feeding at the first feeding speed a. On the one hand, it can integrate multiple production processes into one machine, thereby reducing the time and material costs of transporting raw materials and the first cushion sheet C11 and the second cushion sheet C12. On the other hand, it can improve production efficiency while reducing a space size of the entire packaging bag production device 200.

### A Second Embodiment of the Present Disclosure

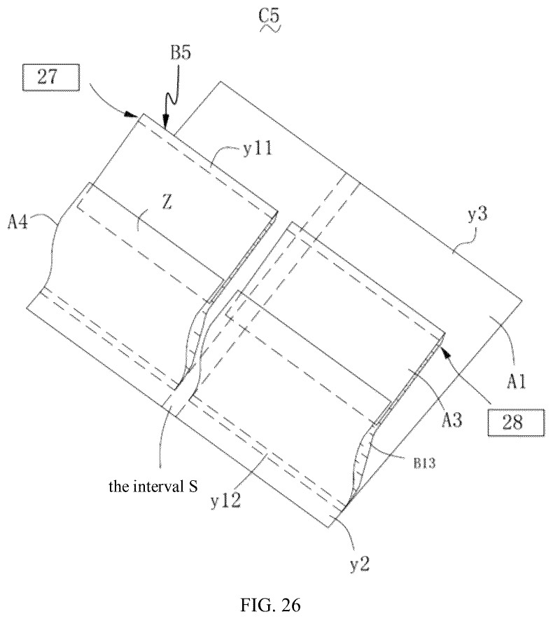

Referring to FIG. 25 and FIG. 26, The packaging bag production device 200 according to the second embodiment of the present disclosure is improved based on the packaging bag production device 200 of the first embodiment, wherein the packaging bag production device 200 of the second embodiment includes two cushion sheet production modules 100, and the cushion sheet production module 100 is selected from any one of the above fourth to sixth embodiments. The cushion sheet production module 100 is configured to produce at least one type of cushion sheet (C4, C5, C6) of the fourth embodiment to the sixth embodiment above mentioned. The cushion sheets (C4, C5, C6) produced by the two cushion sheet production modules 100 are the first cushion sheet C21 and the second cushion sheet C22, respectively. The structure of the first cushion sheet C21 is the same as that of the second cushion sheet C22, and the first cushion sheet C21 and the second cushion sheet C22 are opposite to each other and synchronously fed at the first feeding speed a, and FIG. 23 corresponds to the cushion sheet C5 produced by the above fifth embodiment.

The term “opposite to each other or facing each other” means that the first sheet A1 of the first cushion sheet C11 and the first sheet A1 of the second cushion sheet C12 are arranged on the outer side thereof, while the cushion unit B0 of the first cushion sheet C11 and the cushion unit B0 of the second cushion sheet C12 are positioned between the first sheet A1 of the first cushion sheet C11 and the first sheet A1 of the second cushion sheet C12, thereby ensuring that an outer surface of the packaging bag 300 is formed by the first sheet A1, with the cushion unit B0 being arranged inside the packaging bag 300.

Due to the fact that in the second embodiment, the buffer layers (B4, B5, B6) are not covered by the second sheet A2, the buffer unit B0 is not set at the intervals S of the first sheet A1. At this time, the first bag gluing unit 21 can directly apply the glue at the intervals S, that is, the first positions L1 are the intervals S, which can achieve a purpose of sealing the side edge of the packaging bag 300.

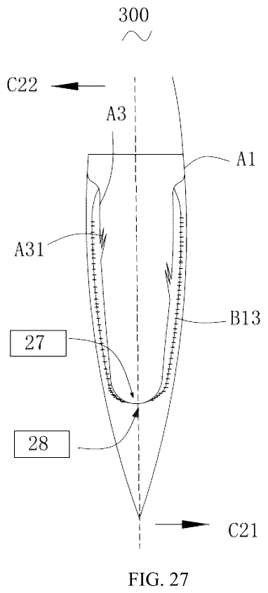

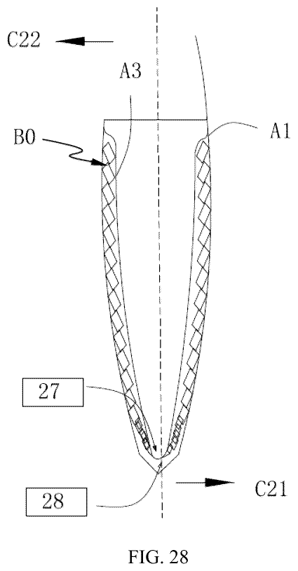

FIG. 27 is a sectional view of the packaging bag 300, the slit paper B13 inside the packaging bag 300 is in an unstretched state, while FIG. 28 is a schematic view of the slit paper B13 inside the packaging bag 300 of FIG. 27 in a stretched state. As shown in FIGS. 27 and 28, the cushion sheet C22 on the left and the cushion sheet C21 on the right are connected together to form the packaging bag 300. The first sheet A1 is located on the outside of the slit paper B13 and the third sheet A3, while the slit paper B13 and the third sheet A3 are located inside the packaging bag 300.

Due to the fact that the packaging bag 300 produced by the packaging bag production device 200 of the second embodiment is a prefabricated packaging bag, that is, the internal slit paper B13 is in the unstretched state as shown in FIG. 27, and the slit paper B13 is only stretched when the packaging bag 300 is used to place items therein. Therefore, the slit paper unit B130 and the third sheet unit A30 can't be connected to the side of the packaging bag 300, that is, the intervals S or corresponding positions of the first sheet A1. Otherwise, the prefabricated packaging bag is unable to be pulled and opened when loaded into items, which naturally can't be converted from a flat structure without buffering performance to the packaging bag 300 with buffering performance. Therefore, it can be seen that the packaging bag production device 200 without providing the buffer layer B0 or the slit paper B13 at the intervals S can improve the production efficiency of production lines, reduce the time for performing side heating and pressing thereon, and be perfectly compatible with producing the prefabricated packaging bags.

On the basis of the packaging bag production device of the first embodiment, the packaging bag production device 200 of the second embodiment of the present disclosure further includes:
a slit paper sizing glue unit 27 arranged at a rear end of the first bag pressing unit 22 along the feeding direction, and configured to apply the glue on the edge of the slit paper B13 of the first cushion sheet C21 and/or the second cushion sheet C22 that is not connected to the first sheet A1, which is used to fix the two buffer layers B0 of the first cushion sheet C21 and the second cushion sheet C22 when producing the packaging bag 300. The two buffer layers B0 are stacked on top of each other and opposite to each other. The fixed position is located on the edges of the two buffer layers B0 that is unconnected to the first sheet A1, such as the edge y11 of FIG. 26. As shown in FIG. 28, the position that the glue is applied by the slit paper sizing glue unit 27 is marked, which is located on the side of the first cushion sheet C21 that is not attached to the first sheet A1, and faces the pocket of the packaging bag 300. At this time, the pasting position is configured to connect the second cushion sheet C22 on the left and the first cushion sheet C21 on the right at the edges thereof. Since the width of the slit paper B13 and the width of the third sheet A3 that are perpendicular to the feeding direction are smaller than the width of the first sheet A3, the slit paper B13 that is unstretched is suspended at the bottom of the packaging bag 300.

In the second embodiment of the present disclosure, the two buffer layers B0 of the first cushion sheet C21 and the second cushion sheet C22 are fixed with each other according to the second embodiment, and the first cushion sheet C21 and the second cushion sheet C22 are fixed at two intervals S to form the side of the packaging bag 300 by using the packaging bag production device 200 of the first embodiment described above. The first sheets A1 of the two cushion sheets (C21, C22) are fixed to each other at one position along the feeding direction (the edge y11 in FIG. 26). After performing the above, a new type of the bottom of the prefabricated packaging bag 300 has been formed.

In the second embodiment, as shown in FIG. 25, FIG. 27 and FIG. 28, the packaging bag production device 200 further includes a bag bottom fixed gluing unit 28 arranged at a rear end of the first bag pressing unit 22 along the feeding direction, and configured to apply the glue on the surface of the slit paper B13 facing the first sheet A1. The position that the glue is applied by the bag bottom fixed gluing unit 28 is located on a side edge of the slit paper B13 that is not fixed to the first sheet A1 along the feeding direction, such as the edge y11 as shown in FIG. 26 that faces the surface of the first sheet A1. The bag bottom fixed gluing unit 28 is configured to fix the slit paper B13 to the bottom of the packaging bag 300 that is formed by the first sheet A1 after the slit paper B13 is stretched, such as the bottom y3 of FIG. 24, to prevent the slit paper B13 from being rebounded. As shown in FIG. 27, the positions that the glue is applied by the bag bottom fixed gluing unit 28 are located on the surface of the slit paper B13 facing the first sheet A1, and on the side edge of the slit paper B13 that is unconnected to the first sheet A1, which is also the bottom y3 of FIG. 26. When the slit paper B13 of FIG. 27 is stretched, the position that the glue is applied by the bag bottom fixed gluing unit 28 move towards the bottom of the packaging bag 300, and finally adheres to the first sheet A1, that is, the bottom of the packaging bag 300, which can prevent the stretched slit paper B13 from being contracted.

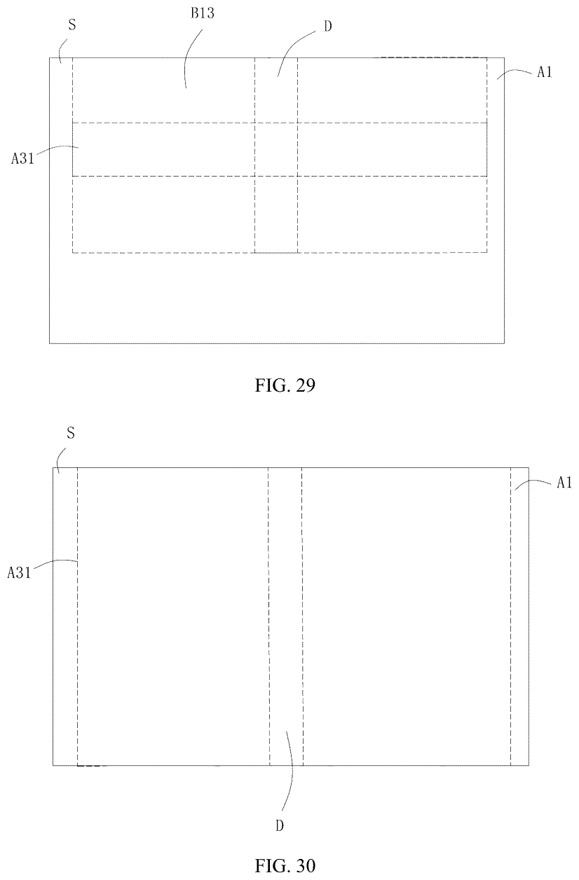

As shown in FIG. 29, the mark D shown in FIG. 29 is the overlapping area Z of two adjacent slit paper units B130, and the interval S is also marked, so it can be seen that the interval S happens to be the two sides of the packaging bag 300. At the same time, the wrinkles A31 are also marked in FIG. 29, which are the wrinkles A31 formed on the third sheet A3. It can be seen from FIG. 29 to FIG. 30 that a length of the wrinkles A31 increases after the slit paper B13 is stretched.

The cushion sheet production module of the present disclosure does not have the buffer layer or the slit paper at fixed compression positions, that is, at the intervals S, so it does not need to undergo long-term compression and heating, and also produced by a rolling and continuous feeding mode, so that there is no stopping situations of using the step compression feeding mode, which is conducive to improving production efficiency, and can achieve a feeding production speed of 100-150 m per minute, thereby greatly improving the production efficiency compared to conventional production with the step feeding mode.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. A cushion sheet production module configured to produce a cushion sheet and comprising a feeding direction to produce the cushion sheet, the cushion sheet comprising a first sheet and a buffer layer, the cushion sheet production module comprising:
a first unreeling unit configured to unreel the first sheet at a first feeding speed, wherein the first sheet is continuously fed along the feeding direction after the first sheet is unreeled;
a buffer layer feeding unit configured to unreel the buffer layer at a changing speed along the feeding direction, the buffer layer arranged above or below the first sheet and opposite to the first sheet, wherein a surface of the buffer layer facing the first sheet is coated with glue, or a surface of the first sheet facing the buffer layer is coated with glue, or the surfaces of the buffer layer and the first sheet facing each other are coated with glue, the glue configured to paste the first sheet and the buffer layer together;
a cutting unit arranged behind the buffer layer feeding unit along the feeding direction, and configured to roll and cut the buffer layer during feeding the buffer layer, positions that the buffer layer are cut arranged on the buffer layer at intervals and set perpendicular to the feeding direction; and wherein
the buffer layer is cut to be separated into a plurality of cushion units arranged in a row from beginning to end, each of the plurality of cushion units comprising a first end and a second end arranged along the feeding direction and opposite to each other, the second end of a previous cushion unit adjacent to the first end of a current cushion unit;
a paper pressing unit arranged behind the cutting unit along the feeding direction and configured to roll and press against positions of the glue set on the first sheet and/or the buffer layer to paste the first sheet and the buffer layer; and wherein each cushion unit is sequentially fed to the paper pressing unit from the first end to the second end, and the plurality of cushion units are fixed on the first sheet after the plurality of cushion units is pressed against by the paper pressing unit; and wherein
the changing speed comprises a second feeding speed and a third feeding speed, the third feeding speed equal to the first feeding speed and the second feeding speed smaller than the first feeding speed; and wherein
a plurality of intervals is formed on the first sheet, each of the plurality of intervals arranged between the first end of the current cushion unit and the second end of the previous cushion unit; and wherein after the buffer layer is cut by the cutting unit, the buffer layer feeding unit is continuously fed at the second feeding speed, until one of the plurality of intervals is reserved on the first sheet, and when the first end of the current cushion unit is fixed on the first sheet, the buffer layer feeding unit is fed at the third feeding speed continuously and synchronously with the first sheet.

2. The cushion sheet production module as claimed in claim 1, wherein the cushion sheet production module further comprises a first sizing glue unit arranged in front of the paper pressing unit along the feeding direction and configured to continuously apply the glue to the buffer layer and/or the first sheet for pasting the first sheet and the buffer layer together.

3. The cushion sheet production module as claimed in claim 2, wherein the cushion sheet production module further comprises:
a second unreeling unit configured to unreel a second sheet along the feeding direction, the first sheet and the second sheet arranged opposite to each other and continuously fed synchronously along the feeding direction, and the buffer layer arranged between the first sheet and the second sheet; and wherein
the glue is applied on positions that a surface of the second sheet is oriented towards the first sheet and are corresponding to the plurality of intervals, or the glue is applied on the plurality of intervals of a surface of the first sheet that is oriented towards the second sheet; and
a rolling-pressing unit arranged behind the second unreeling unit along the feeding direction and configured to roll and press against the plurality of intervals of the first sheet, and positions of the second sheet that correspond to the plurality of intervals, for fixing the first sheet and the second sheet in a direction perpendicular to the feeding direction, each of the plurality of cushion units arranged between two adjacent intervals and wrapped by both the first sheet and the second sheet.

4. The cushion sheet production module as claimed in claim 3, wherein the cushion sheet production module further comprises:
a second sizing glue unit arranged in front of the rolling-pressing unit along the feeding direction and configured to continuously apply the glue on the surface of the second sheet facing the first sheet, to connect two edges of the first sheet and the second sheet along the feeding direction.

5. The cushion sheet production module as claimed in claim 4, wherein the buffer layer comprises at least one layer of pads, and a structure of the at least one layer of pads is selected from at least one of a wavy corrugated paper structure, a concave convex structure, a plastic bubble film, and a three-dimensional hexagonal grid structure that is stretched by a slit paper.

6. The cushion sheet production module as claimed in claim 5, wherein the at least one layer of pads of the buffer layer comprises a plurality of layers of pads, and the cushion sheet production module comprises a plurality of cutting units and a plurality of sizing glue units, the buffer layer feeding unit comprising a plurality of pad feeding units, wherein quantities of the plurality of pad feeding units, the plurality of first sizing glue units, the plurality of cutting units, and the plurality of layers of pads are the same, each of the plurality of pad feeding units configured to feed one of the plurality of layers of pads, at least one of the plurality of first sizing glue units configured to continuously apply the glue to a surface of one layer of pads that faces an adjacent layers of pads, each of the plurality of cutting units configured to cut one layer of pads, and the plurality of layers of pads stacked up and down and continuously and synchronously fed; and wherein
when one layer of pads is cut, positions that the layer of pads is continuously applied the glue, are connected to the adjacent layer of pads.

7. The cushion sheet production module as claimed in claim 2, wherein the buffer layer feeding unit comprises:
a third unreeling unit configured to unreel a third sheet at a speed along the feeding direction to make the third sheet to be continuously fed along the feeding direction, wherein the third sheet is provided with wrinkles extending along the feeding direction;
a slit paper unreeling unit configured to unreel a slit paper along the feeding direction to make the slit paper to be continuously fed along the feeding direction, the slit paper arranged between the first sheet and the third sheet; and wherein
both the slit paper and the third sheet are unreeled synchronously, and the two edges of the slit paper and the two edges of the third sheet along the feeding direction are connected to each other, each of a width of the slit paper perpendicular to the feeding direction and a width of the third sheet perpendicular to the feeding direction smaller than a width of the first sheet perpendicular to the feeding direction; and wherein the slit paper and the third sheet are connected to form the buffer layer, the glue applied by the first sizing glue unit is only arranged on one of the two edges of the first sheet or the slit paper along the feeding direction, so that the buffer layer is connected with the one edge of the first sheet along the feeding direction, while the buffer layer is not connected with the other edge of the first sheet along the feeding direction.

8. A packaging bag production device comprising two cushion sheet production modules as claimed in claim 1, the two cushion sheet production modules configured to produce two cushion sheets, respectively, wherein the two cushion sheets produced by the two cushion sheet production modules are respectively taken as a first cushion sheet and a second cushion sheet, the first cushion sheet and the second cushion sheet are stacked vertically opposite to each other and synchronously fed along the feeding direction; and wherein
a structure of the first cushion sheet is the same as that of the second cushion sheet, the first sheet of the first cushion sheet arranged above the buffer layer of the first cushion sheet, the buffer layer of the first cushion sheet arranged above the buffer layer of the second cushion sheet, and the first sheet of the second cushion sheet arranged below the buffer layer of the second cushion sheet, the first sheets of the first cushion sheet the second cushion sheet comprising the plurality of intervals; and wherein
the packaging bag production device further comprises:
a first bag gluing unit arranged behind the first unreeling unit along the feeding direction and configured to apply glue on the first cushion sheet and/or the second cushion sheet, first positions of the first cushion sheet and/or the second cushion sheet that the glue is applied by the first bag gluing unit arranged at intervals, and a direction of the first positions that are applied the glue perpendicular to the feeding direction, wherein the first positions are arranged on the plurality of intervals of the first cushion sheet or the second cushion sheet, or are arranged on positions that are corresponding to the plurality of intervals of the first cushion sheet; wherein the first positions are set on a surface of the first cushion sheet facing the second cushion sheet, or set on a surface of the second cushion sheet facing the first cushion sheet, or set on the surface of the first cushion sheet facing the second cushion sheet and the surface of the second cushion sheet facing the first cushion sheet, respectively;
a first bag pressing unit arranged behind the first bag gluing unit along the feeding direction and configured to roll and press against the first cushion sheet and the second cushion sheet to connect the first cushion sheet and the second cushion sheet at the first positions thereof, to form two sides of a packaging bag.

9. The packaging bag production device as claimed in claim 8, wherein the packaging bag production device further comprises:
a second bag gluing unit arranged behind the first unreeling unit along the feeding direction and configured to apply the glue on second positions of a surface of the first cushion sheet and a surface of the second cushion sheet that are opposite to each other, the second positions continuously arranged along the feeding direction and only set on one lateral edge along the feeding direction, while no glue applied to the other lateral edge along the feeding direction; and wherein
a second bag pressing unit is arranged behind the second bag gluing unit along the feeding direction and configured to roll and press against the first cushion sheet and the second cushion sheet, so that the first cushion sheet and the second cushion sheet are pressed against each other at the second positions, to form a bottom of the packaging bag, and a pocket is formed at the other lateral edges of the first cushion sheet and the second cushion sheet that have not been glued.

10. The packaging bag production device as claimed in claim 9, wherein the packaging bag production device further comprises:
a bottom flipping unit arranged behind the second bag gluing unit along the feeding direction and arranged between the second bag gluing unit and the second bag pressing unit, the bottom flipping unit configured to flip the second positions of the first cushion sheet and/or the second cushion sheet, so that the first cushion sheet wraps edges of the second cushion sheet, or the second cushion sheet wraps edges of the first cushion sheet; and wherein
the second bag pressing unit is configured to press the folded position of the first cushion sheet or the second cushion sheet to form the bottom of the packaging bag.

11. The packaging bag production device as claimed in claim 8, wherein the cushion sheet production module comprises a first sizing glue unit arranged in front of the paper pressing unit along the feeding direction and configured to continuously apply the glue to the buffer layer and/or the first sheet for pasting the first sheet and the buffer layer together.

12. The packaging bag production device as claimed in claim 11, wherein the cushion sheet production module comprises:
a second unreeling unit configured to unreel a second sheet along the feeding direction, the first sheet and the second sheet arranged opposite to each other and continuously fed synchronously along the feeding direction, and the buffer layer arranged between the first sheet and the second sheet, wherein the second sheet is provided with a plurality of lateral positions corresponding one-to-one with the plurality of intervals, the plurality of lateral positions arranged on the surface of the first cushion sheet facing the second cushion sheet, or on the surface of the second cushion sheet facing the first cushion sheet, and arranged between the first end of the current cushion unit and the second end of the previous cushion unit of the first cushion sheet or the second cushion sheet, wherein the glue is applied on the plurality of lateral positions; and wherein
a rolling-pressing unit is arranged behind the second unreeling unit along the feeding direction and configured to roll and press against the first sheet and the second sheet, to connect the first cushion sheet and the second cushion sheet at the plurality of lateral positions, the first and second sheets are fixed with each other along a direction perpendicular to the feeding direction, each of the plurality of cushion units arranged between two adjacent intervals and wrapped by both the first sheet and the second sheet.

13. The packaging bag production device as claimed in claim 12, wherein the cushion sheet production module further comprises:
a second sizing glue unit arranged behind the first unreeling unit along the feeding direction and configured to continuously apply the glue to the surface of the second sheet facing the first sheet, to connect the first sheet and the second sheet in the feeding direction, wherein a position of the second sheet that is applied the glue is at least one edge of the second sheet along the feeding direction.

14. The packaging bag production device as claimed in claim 12, wherein the buffer layer comprises at least one layer of pads, and a structure of the at least one layer of pads is selected from at least one of a wavy corrugated paper structure, a concave convex structure, a plastic bubble film, and a three-dimensional hexagonal grid structure that is stretched by a slit paper.

15. The packaging bag production device as claimed in claim 14, wherein the at least one layer of pads of the buffer layer comprises a plurality of layers of pads, and the cushion sheet production module comprises a plurality of cutting units and a plurality of sizing glue units, the buffer layer feeding unit comprising a plurality of pad feeding units, wherein quantities of the plurality of pad feeding units, the plurality of first sizing glue units, the plurality of cutting units, and the plurality of layers of pads are the same, each of the plurality of pad feeding units configured to feed one of the plurality of layers of pads, at least one of the plurality of first sizing glue units configured to continuously apply the glue to a surface of one layer of pads that faces an adjacent layers of pads, each of the plurality of cutting units configured to cut one layer of pads, and the plurality of layers of pads stacked up and down and continuously and synchronously fed; and wherein
when one layer of pads is cut, positions that the layer of pads is continuously applied the glue, are connected to the adjacent layer of pads.

16. The packaging bag production device as claimed in claim 11, wherein the buffer layer feeding unit comprises:
a third unreeling unit configured to unreel a third sheet at a speed along the feeding direction to make the third sheet to be continuously fed along the feeding direction, wherein the third sheet is provided with wrinkles extending along the feeding direction;
a slit paper unreeling unit configured to unreel a slit paper along the feeding direction to make the slit paper to be continuously fed along the feeding direction, the slit paper arranged between the first sheet and the third sheet; and wherein
the slit paper is unreeled synchronously with the third sheet, and two edges of the slit paper along the feeding direction and two edges of the third sheet along the feeding direction are connected to each other, each of a width of the slit paper perpendicular to the feeding direction and a width of the third sheet perpendicular to the feeding direction smaller than a width of the first sheet perpendicular to the feeding direction; and wherein the slit paper and the third sheet are connected to form the buffer layer, the glue applied by the first sizing glue unit is only arranged on one of the two edges of the first sheet or the slit paper along the feeding direction, so that the buffer layer is connected with the one edge of the first sheet along the feeding direction, while the buffer layer is not connected with the other edge of the first sheet along the feeding direction.

17. A cushion sheet production module having a feeding direction and comprising:
a first unreeling unit configured to unreel a first sheet at a first feeding speed, wherein the first sheet is continuously fed along the feeding direction after the first sheet is unreeled;
a third unreeling unit configured to unreel a third sheet at a speed along the feeding direction to make the third sheet to be continuously fed along the feeding direction, wherein the third sheet is provided with wrinkles extending along the feeding direction;
a slit paper unreeling unit configured to unreel a slit paper at a changing speed along the feeding direction to make the slit paper to be continuously fed along the feeding direction, the slit paper arranged between the first sheet and the third sheet, wherein a surface of the slit paper facing the third sheet is provided with the glue, or a surface of the third sheet facing the slit paper is provided with the glue, and the glue is set along two edges in the feeding direction, and configured to paste at the two edges of the slit paper and the third sheet in the feeding direction;
and wherein the one edge of the slit paper that faces the surface of the first sheet along the feeding direction is provided the glue, or the glue is provided on the surface of the first sheet corresponding to the one edge of the slit paper along the feeding direction, for only connecting the one edge of the slit paper along the feeding direction to the first sheet;
a slit paper cutting unit arranged behind the slit paper unreeling unit along the feeding direction and configured to cut the slit paper;
a cutting unit arranged behind the third unreeling unit along the feeding direction and configured to roll and cut the third sheet during feeding the third sheet, cutting positions of the third sheet arranged on the third sheet at intervals and perpendicular to the feeding direction;
a paper pressing unit arranged behind the cutting unit along the feeding direction and configured to roll and press against the first sheet, so that the first sheet is connected to the one edge of the slit paper that is applied the glue, and the two edges of the slit paper that are applied the glue are connected to the third sheet; and wherein
the slit paper is cut to be separated into a plurality of slit paper units sequentially arranged in a row from beginning to end, the third sheet is cut to be separated into a plurality of third sheet units sequentially arranged in a row from beginning to end, each adjacent two slit paper units connected to one of the plurality of third sheet units, to form a corresponding cushion unit vertically;
the plurality of cushion units arranged in a row from beginning to end, each of the plurality of cushion units comprising a first end and a second end arranged along the feeding direction and opposite to each other, the second end of a previous cushion unit adjacent to the first end of a current cushion unit; and wherein each cushion unit is sequentially fed to the paper pressing unit from the first end to the second end, and the plurality of cushion units are fixed on the first sheet after the plurality of cushion units is pressed against by the paper pressing unit; and wherein
each of the plurality of slit paper units comprises a third end and a fourth end opposite to each other along the feeding direction, and in the same cushion unit, the fourth end of a current slit paper unit corresponding to the second end of the cushion unit, and the third end of a previous slit paper unit corresponding to the first end of the cushion unit; and wherein
each of the plurality of third sheet units comprises a fifth end and a sixth end opposite to each other along the feeding direction, and in the same cushion unit, the fifth end of a current third sheet unit corresponding to the first end of the cushion unit, and the sixth end of a next third sheet unit corresponding to the second end of the cushion unit; and wherein
a plurality of intervals is formed on the first sheet, each of the plurality of intervals arranged between the first end of the current cushion unit and the second end of the previous cushion unit, the plurality of intervals arranged along a direction perpendicular to the feeding direction, and arranged along the feeding direction at intervals; and wherein
the changing speed comprises a second feeding speed, a third feeding speed and a fourth feeding speed, the third feeding speed equal to the first feeding speed, the second feeding speed smaller than the first feeding speed, and the fourth feeding speed greater than the first feeding speed; and wherein
the feeding speed of the third unreeling unit comprises the second feeding speed and the third feeding speed; and wherein
when the fifth end of the current third sheet unit corresponds to an end position of the interval of the first sheet, the third unreeling unit feeds the third sheet at the third feeding speed, so that the third sheet is fed synchronously with the first sheet; and when the sixth end of the current third sheet unit corresponds to a starting position of the interval of the first sheet, the third unreeling unit feeds the third sheet at the second feeding speed until the fifth end of the next third sheet unit corresponds to the starting position of an adjacent interval of the first sheet; and wherein
when the third end of the previous slit paper unit corresponds to the end position of the interval of the first sheet, the slit paper unreeling unit feeds the slit paper at the third feeding speed, so that the slit paper is synchronously fed with the first sheet and the third sheet; and when the fourth end of the previous slit paper unit is fed to a predetermined position between two adjacent intervals of the first sheet, the slit paper unreeling unit feeds the slit paper at the fourth feeding speed, and the third end of the current slit paper unit that is fed at the fourth feeding speed is overlapped with the fourth end of the previous slit paper unit; and wherein when the third end of the current slit paper unit is overlapped with the fourth end of the previous slit paper unit by a predetermined width, the slit paper unreeling unit continues to feed the slit paper at the third feeding speed until the fourth end of the current slit paper unit is located at the starting position of the adjacent interval, at this time, the slit paper unreeling unit feeds the slit paper at the second feeding speed until the third end of the next slit paper unit corresponds to the ending position of the adjacent interval.

18. The cushion sheet production module as claimed in claim 17, wherein there are two cushion sheet production modules configured to produce two cushion sheets respectively, the two cushion sheet production modules respectively opposite to the third sheet and fed synchronously, and pressed and pasted to each other at the intervals or positions corresponding to the intervals.
